(19) United States
(12) Patent Application Publication
(10) Pub. No.: US 2015/0185460 A1
(43) Pub. Date: Jul. 2, 2015

(54) IMAGE FORMING METHOD AND IMAGE FORMING APPARATUS

(71) Applicant: OLYMPUS CORPORATION, Tokyo (JP)

(72) Inventors: Eiji NAKASHO, Tokyo (JP); Hiroshi ISHIWATA, Tokyo (JP)

(73) Assignee: OLYMPUS CORPORATION, Tokyo (JP)

(21) Appl. No.: 14/571,244

(22) Filed: Dec. 15, 2014

(30) Foreign Application Priority Data
Dec. 26, 2013 (JP) 2013-270349

(51) Int. Cl. G02B 21/16; G02B 21/00

(52) U.S. Cl. CPC G02B 21/16; G02B 21/0056; G02B 21/008

(57) ABSTRACT

An image forming method for a biological sample includes calculating a component corresponding to a phase distribution of the sample and a component corresponding to a matter other than the phase distribution according to a plurality of pieces of images with different image contrasts, to form a normalized phase component; separating the phase component image into a plurality of frequency components according to spatial frequencies of the image; merging the phase distribution of the refraction component and the phase distribution of the structure component calculated by applying a deconvolution process to each of the frequency components using an optical response characteristic corresponding to each, to calculate the phase distribution, and forming a phase distribution image from the calculated phase distribution; and merging the phase distribution image with an image of the sample in which a biochemical phenomenon and/or a physical phenomenon in the sample are visualized.

### CROSS-REFERENCE TO RELATED APPLICATION

This application is based upon and claims the benefit of priority from prior Japanese Patent Application No. 2013-270349, filed Dec. 26, 2013, the entire contents of which are incorporated herein by this reference.

### FIELD

The present invention relates to a method and an apparatus for forming an image of a biological sample, and particularly to a method and an apparatus for forming an image of a biological sample by merging an image based on the phase distribution of the biological sample and an image based on light emitted from the biological sample.

### BACKGROUND

While various observation methods are known as methods for observing a biological cell or a biological tissue (hereinafter, these are collectively referred to as a biological sample), the fluorescence observation method using a fluorescence confocal microscope is the most popular at this moment as the observation method for three-dimensional observation of a biological sample.

However, in the fluorescence observation method, it is possible to visualize a biochemical phenomenon and a physical phenomenon in a biological sample by combining a substance that emits fluorescence (a fluorescent substance) with certain proteins or enzymes, but it is difficult to understand the overall shape of a biological sample or the shape of the biological tissue. This is because only the proteins and the enzymes that are combined with the fluorescent substance emit light under the fluorescence observation method. For example, it is possible to understand the shape of a cell by combining the fluorescent substance with the cell membrane or the cell cytoplasm, but even when such an additional work is done, it is impossible to understand the shape of a cell that is not combined with the fluorescent substance, and it is impossible to understand the overall shape of the biological sample.

For this reason, in recent years, techniques have been proposed in which an image of a biological sample obtained using an observation method that is suitable for visualizing the biochemical phenomenon and the physical phenomenon in the biological sample, such as the fluorescence observation method, with an image of the biological sample obtained using another method that is suitable for understanding the shape and the structure of the biological sample are merged. Then, techniques have been proposed to observe the biological sample using the merged image (hereinafter, an image formed by combining images obtained using different observation methods is referred to as a heterogeneous merged image). A related method is disclosed in Japanese Laid-open Patent Publication No. 09-179034 for example.

Meanwhile, in the techniques mentioned above, the methods in which the phase distribution of a biological sample which is a phase object is visualized by converted it into the image intensity distribution, such as the differential interference contrast (DIC) observation method disclosed in Japanese Laid-open Patent Publication No. 09-179034 and the phase contrast observation method are popular as the observation methods that are suitable for understanding the shape and the structure of the biological sample. Meanwhile, in addition to the fluorescence observation method disclosed in Japanese Laid-open Patent Publication No. 09-179034, any method for detecting light emitted from the biological sample may be used as the observation method that is suitable for visualizing the biochemical phenomenon and the physical phenomenon in a biological sample.

### SUMMARY

An aspect of the present invention provides an image forming method for a biological sample, including capturing optical images of a biological sample formed by a microscope that converts a phase distribution into an image intensity distribution while changing an image contrast, to form a plurality of pieces of images with different image contrasts; calculating a component corresponding to a phase distribution of the biological sample and a component corresponding to a matter other than the phase distribution of the biological sample according to the plurality of pieces of images, and forming a normalized phase component image by dividing the component corresponding to the phase distribution by the component corresponding to the matter other than the phase distribution of the biological sample; separating the phase component image into a plurality of frequency components according to spatial frequencies of the image; applying a deconvolution process to each of the frequency components using an optical response characteristic corresponding to each, to calculate a phase distribution of a refraction component formed by light refracted inside the biological sample and a phase distribution of a structure component formed by light diffracted in a structure inside the biological sample; merging the phase distribution of the refraction component and the phase distribution of the structure component to calculate the phase distribution of the biological sample, and forming a phase distribution image from the calculated phase distribution of the biological sample; and merging the phase distribution image of the biological sample with an image of the biological sample in which a biochemical phenomenon and/or a physical phenomenon in the biological sample are visualized and which is obtained using a method that is different from a method used for the phase distribution image.

Another aspect of the present invention provides an image forming apparatus including a microscope that converts a phase distribution of a biological sample into an image intensity distribution and that includes an image contrast changing unit which changes an image contrast of the image intensity distribution; a control unit which controls the image contrast changing unit so as to obtain a plurality of pieces of images with different image contrasts; an operating unit which calculates a component corresponding to the phase distribution of the biological sample and a component corresponding to a matter other than the phase distribution of the biological sample according to the plurality of pieces of images obtained with control by the control unit, and forms a normalized phase component image by dividing the component corresponding to the phase distribution by the component corresponding to the matter other than the phase distribution of the biological sample; separating the phase component image into a plurality of frequency components according to spatial frequencies of the image; applies a deconvolution process to each of the frequency components using an optical response characteristic corresponding to each, to calculate a phase distribution of a refraction component formed by light refracted inside the biological sample and a phase distribution of a structure component formed by light diffracted in a structure inside the biological sample; and merges the phase distribution of the refraction component and the phase distribution of the structure component to calculate the phase distribution of the biological sample, and forms a phase distribution image from the calculated phase distribution of the biological sample; and a merging unit which merges an image of the biological sample in which a biochemical phenomenon and/or a physical phenomenon in the biological sample are visualized and which is obtained using a method that is different from a method used for the phase distribution image with the phase distribution image of the biological sample formed by the operating unit.

### BRIEF DESCRIPTION OF DRAWINGS

The present invention will be more apparent from the following detailed description when the accompanying drawings are referenced;

FIG. 1 is a flowchart of a phase distribution measurement method according to an embodiment of the present invention;

FIG. 2 is another flowchart of a phase distribution measurement method according to an embodiment of the present invention;

FIG. 3 is a diagram illustrating the optical response characteristic corresponding to the structure component in the focused state with respect to the observation plane;

FIG. 4 is diagram for explaining the three-dimensional structure of a biological sample.

FIG. 5 is a diagram schematically illustrating the phase distribution obtained according to the optical response characteristic in the focused state;

FIG. 6 is a diagram for explaining an example of a method to reconstruct the phase distribution in which defocusing has caused a blur;

FIG. 7 is a diagram illustrating the optical response characteristic corresponding to the structure component in the defocused state with respect to the observation plane;

FIG. 8 is yet another flowchart of a phase distribution measurement method according to an embodiment of the present invention;

FIG. 9 is a diagram for explaining another example of a method to reconstruct the phase distribution in which defocusing has caused a blur;

FIG. 10 is a flowchart of a heterogeneous merged image forming method according to an embodiment of the present invention;

FIG. 11 is a diagram illustrating an example of the configuration of the microscope system according to Embodiment 1 of the present invention;

FIG. 12 is a diagram illustrating the optical response characteristic corresponding to the refraction component in the focused state with respect to the observation plane;

FIG. 13A presents rating the phase distribution of iPS cells obtained by the microscope system illustrated in FIG. 11;

FIG. 13B presents the phase distribution of iPS cells obtained by the microscope system illustrated in FIG. 11 when the observation position is changed upward by 3 μm in the optical axis direction from the observation position in FIG. 13A;

FIG. 13C presents the phase distribution of iPS cells obtained by the microscope system illustrated in FIG. 11 when the observation position is changed upward by 3 μm in the optical axis direction from the observation position in FIG. 13B;

FIG. 14 is a flowchart of a heterogeneous merged image forming method according to Embodiment 1 of the present invention;

FIG. 15 is a diagram illustrating an example of the configuration of the microscope system according to Embodiment 2 of the present invention;

FIG. 16 is a diagram for explaining the rotation of a polarization plate included in the microscope system illustrated in FIG. 15;

FIG. 17 is a diagram illustrating an example of the configuration of the microscope system according to Embodiment 3 of the present invention;

FIG. 18A presents a phase distribution image of cells of crypt tissue in the small intestine obtained by the microscope system illustrated in FIG. 17;

FIG. 18B presents a fluorescence image of cells of the crypt tissue in the small intestine illustrated in FIG. 18A;

FIG. 18C presents an image in which images presented in FIG. 18A and FIG. 18B are merged.

FIG. 19 is a diagram illustrating an example of the configuration of a microscope system according to Embodiment 4 of the present invention;

FIG. 20 is a flowchart of a heterogeneous merged image forming method according to Embodiment 4 of the present invention;

FIG. 21 is a diagram illustrating an example of the configuration of a microscope system according to Embodiment 5 of the present invention;

FIG. 22 is a diagram illustrating an example of the configuration of a microscope system according to Embodiment 6 of the present invention;

FIG. 23 is a diagram illustrating an example of the configuration of a microscope system according to Embodiment 7 of the present invention;

FIG. 24 is a diagram illustrating an example of the configuration of a microscope system according to Embodiment 8 of the present invention; and

FIG. 25 is a diagram illustrating an example of the configuration of a microscope system according to Embodiment 9 of the present invention.

### DESCRIPTION OF EMBODIMENTS

According to the DIC observation method, in the strict sense, the differential values of the phase distribution of a biological sample are visualized, and the phase distribution itself is not visualized. Meanwhile, the phase contrast observation method is similar to the DIC observation method in that the phase distribution itself is not visualized. Furthermore, with the DIC observation method and the phase contrast observation method, there is a problem wherein the generated image is strongly affected by a blurred image of a plane deviated from the focal plane, because no sectioning effect is generated.

For these reasons, it is difficult with the DIC observation method and the phase contrast observation method to understand the exact shape and structure of a biological sample. Therefore, it is difficult to accurately understand the position of apart in a biological sample in which a biochemical phenomenon and/or a physical phenomenon is happening or to accurately understand the influence of the biochemical phenomenon and/or the physical phenomenon on the shape and the structure of the biological sample, from a heterogeneous merged image formed using images obtained according to these observation methods.

In view of the situation described above, the embodiments of the present invention are explained below.

First, the biological sample which is a sample to which the present invention is explained.

A biological sample in a three-dimensional structure has a characteristic that, while it is colorless and transparent, the biological sample causes a change in the phase of light that passes through it according to the difference in its internal composition and the like. For this reason, a biological sample may be regarded as a phase object that has a phase distribution which changes three-dimensionally and continuously. Therefore, it is possible to find the three-dimensional structure of the biological sample, by obtaining the three-dimensional phase distribution of the biological sample.

In the present invention, the phase distributions in the observation area that has a certain thickness in the optical axis direction in the biological sample (phase object) are detected. The three-dimensional phase distribution of the biological sample is obtained by connecting phase distributions of different observation areas at different positions in the optical axis direction. This technique is totally different from the technique of the fluorescence confocal microscope in which the three-dimensional position coordinates of fluorescent pigments in an observed object are detected and a three-dimensional image is formed from the detected position coordinates.

Next, the results of researches by the inventor of the present invention related to the measurement of the phase distribution of phase objects in general not limited to biological samples and new problems found by the inventor of the present invention related to the measurement of the phase distribution of phase objects are outlined below. Japanese Laid-open Patent Publication No. 2008-102294 discloses that a phase object has a characteristic that, when the bright field observation is performed, no image is generated on the focal position, but an image contrast is generated at a position deviated from the focus. Meanwhile, Japanese Laid-open Patent Publication No. 9-15504 discloses that the image intensity distribution at the time when a phase object is observed with a differential interference contrast microscope includes plurality of image components in addition to the image intensity distribution that represents the differential values of the phase distribution.

The inventor of the present invention newly found that the plurality of image components presented in Japanese Laid-open Patent Publication No. 9-15504 included the image component caused by defocusing presented in Japanese Laid-open Patent Publication No. 2008-102294. Furthermore, the inventor of the present invention newly found that when a phase object has a three-dimensional structure, the image component caused by defocusing (the image component according to the phase distribution of the portion outside the observation area) also has an influence that is not negligible on the observation.

Meanwhile, Japanese Laid-open Patent Publication No. 9-15504 discloses that a plurality of pieces of images whose image contrasts are changed by changing the retardation amounts of two polarized lights generated in a differential interference contrast microscope are captured, and a subtraction operation and a summing operation are applied to them. Furthermore, it is disclosed that, by normalizing the obtained subtraction image using the obtained sum image, it is possible to obtain only the image component in which the optical response characteristic (also called OTF: Optical Transfer Function) is convolved with the phase distribution of a phase object. This technique uses the fact that when the retardation amount of the polarization light is changed without shifting the observation position, the image component corresponding to the amount of defocusing presented in Japanese Laid-open Patent Publication No. 2008-102294 does not change. More specifically, the image component corresponding to the amount of defocusing is removed by applying a subtraction operation to images obtained with symmetrically-varied retardation amounts (±8) of the polarization lights, to obtain the image intensity distribution in which the phase distribution of the observed object and the optical response characteristic of the differential interference contrast microscope are convolved. In addition, Japanese Laid-open Patent Publication No. 9-15504 also discloses that the phase distribution of the observed object may be obtained by deconvolution of the image intensity distribution calculated as described above, using the optical response characteristic of the differential interference contrast microscope.

The value of the optical response characteristic of a differential interference contrast microscope nears zero in the low frequency band where the spatial frequency is close to zero and in the frequency band around the cutoff frequency. Therefore, division by zero may occur in the deconvolution process, but this problem may be improved by arranging the Wiener filter. Japanese Laid-open Patent Publication No. 2006-300714 presents a problem wherein such an arrangement leads to a decrease in the accuracy in obtaining the phase distribution of an object that has gentle gradient, and Japanese Laid-open Patent Publication No. 2006-300714 discloses that this problem may be improved by partially applying integration processing.

The inventor of the present invention newly found that, particularly in the observation of a biological sample, a false image may be generated when the deconvolution process is performed, because there are many parts in which the phase distribution has gentle gradient in the nucleus or the like, and that a sequence of noises may be generated when the integration process is performed, because there are many granular tissues and the like. In addition, the inventor of the present invention also found that a slight deviation in the localize position of the Nomarski prism causes irregularity in the field of view and causes undulation in the observation area, because a biological sample (such as a biological tissue or a cell colony) has a structure that extends in the optical axis direction.

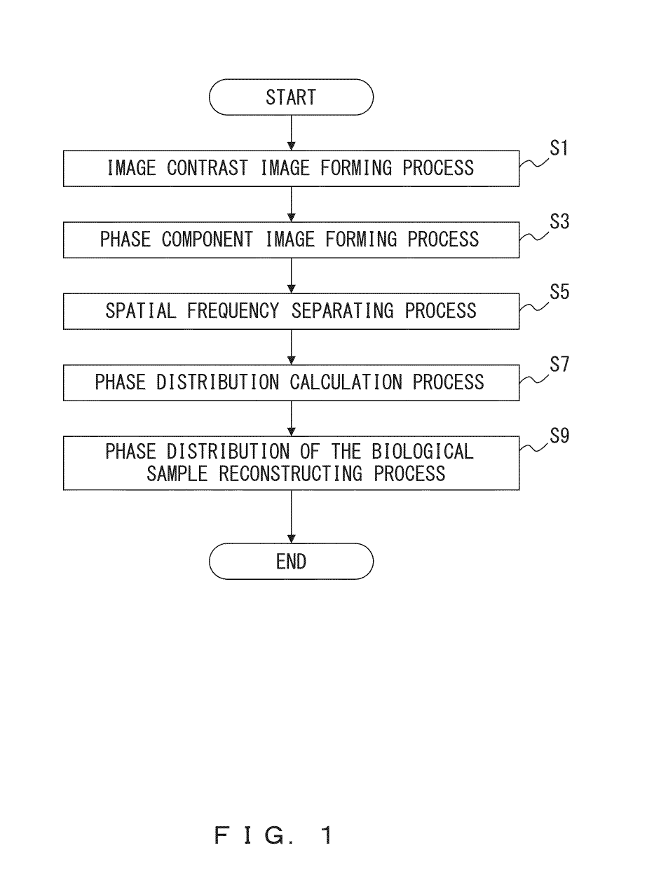

Hereinafter, a method for improvement in these new problems to obtain the phase distribution in a biological sample with a good accuracy is explained with reference to FIG. 1.

First, optical images of a biological sample formed by a microscope such as a differential interference contrast microscope that converts the phase distribution into the image intensity distribution are captured while changing the image contrast at the imaging device, to form a plurality of pieces of images with different image contrasts (step S1 in FIG. 1 (Image contrast image forming process)).

Then, the component corresponding to the phase distribution of the biological sample and the component corresponding to matters other than the phase distribution of the biological sample are calculated according to the plurality of pieces of images formed. The component corresponding to matters other than the phase distribution of the biological sample include, for example, the component according to the absorption of the biological sample or the component according to the illumination distribution, or the like. After that, an image of the component corresponding to the normalized phase distribution (hereinafter, referred to as a normalized phase component image) is formed by dividing the calculated component corresponding to the phase distribution by the component corresponding to the matters other than the phase distribution (step S3 in FIG. 1 (Phase component image forming process)). Meanwhile, this procedure is disclosed in Japanese Laid-open Patent Publication No. 09-015504, for example.

Next, the obtained normalized phase component image is separated into the background image whose spatial frequency is the lowest, the refraction component formed by light refracted inside the biological sample, and the structure component whose spatial frequency is the highest formed by light diffracted in the structure inside the biological sample. That is, the normalized phase component image is separated into a plurality of frequency components according to the spatial frequencies of the image (step S5 in FIG. 1 (Spatial frequency separating process)).

Meanwhile, the irregularity in the field of view consists of the frequency components of about four periods at most within the observation range in terms of the spatial frequencies, and therefore, its influence is expected to appear in the background component. In addition, parts of the biological sample in which the phase distribution has gentle gradient, such as the nucleus for example, have a frequency band which is about one tenth of the cutoff frequency of the microscope at most, and therefore, the parts are detected as the refraction component. In addition, fine structures in the biological sample, such as granular tissues for example, have a higher frequency band compared with the frequency band of the components mentioned above, and therefore, the fine structures are detected as the structure component.

Then, a deconvolution process is applied to each of the refraction component and the structure component that are the image intensity distribution, with the optical response characteristic corresponding to each, to calculate the phase distribution of the refraction component and the phase distribution of the structure component separately (step S7 in FIG. 1 (Phase distribution calculating process)). Then, they are merged to calculate the phase distribution of the biological sample, and a phase distribution image is formed from the calculated phase distribution (step S9 in FIG. 1 (Phase distribution of the biological sample reconstructing process)).

As described above, the normalized phase distribution image is separated into three components, and then, the two components except the background component, namely the refraction component and the structure component are used for the deconvolution process. Accordingly, the influence of the irregularity in the field of view appearing in the background process may be suppressed. In addition, the deconvolution process is applied to the refraction component and the structure component with a different optical response characteristic corresponding to each of them. Accordingly, the generation of a false image or the sequence of noises may be suppressed. Therefore, according to this method, a more accurate phase distribution of the biological sample may be obtained. In addition, a phase distribution image that makes it possible to accurately understand the shape and the structure of the biological sample may be formed from the accurate phase distribution of the biological sample.

Meanwhile, when the normalized phase component image is separated into the three frequency components by Fourier transform focusing only on the frequency, the separation may cause noises. Therefore, in the method described above, it is desirable to use low-pass filtering to apply an averaging process to the image, when separating the normalized phase component image into the three components. For example, an image of the background component is formed by performing a plurality of convolution processes using an averaging filter that has a relatively large averaging area. Then, an image of the refraction component is formed by performing a plurality of convolution processes to an image obtained by subtracting the image of the background component from the normalized phase component image, using an averaging filter with a smaller averaging area than that for the background component. Lastly, an image of the structure component is formed by subtracting the image of the background component and the image of the refraction component from the normalized phase component image. As described above, it is desirable to separate the normalized phase component image into the background component, the refraction component and the structure component while applying the image averaging process using filters with different kernel sizes to the normalized phase component image.

Meanwhile, when using a differential interference contrast microscope, it is difficult to calculate the phase distribution in the shear direction from the image intensity distribution of the image, because it is impossible to obtain the image contrast corresponding to the phase distribution for the vertical direction with respect to the shear direction. For this reason, it is desirable to calculate the phase distributions in two orthogonal shear directions using the method illustrated in FIG. 1 by switching the shear direction, and to merge the obtained phase distributions. Meanwhile, the technique to merge two phase distributions obtained with the switching of the shear direction is also disclosed in Japanese Laid-open Patent Publication No. 9-15504.

In order to obtain differential interference contrast images in two shear direction in step S1 for example, using the method illustrated in FIG. 1, there is a need to switch the shear direction by changing Nomarski prisms or by rotating a single Nomarski prism. The switching causes a shift of the image by about several pixels, even when the parallelism or the mounting angle or the like of the Nomarski prism is adjusted. For this reason, it is difficult to avoid positional deviation from appearing in the calculated phase distributions. Then, when these phase distributions are merged without correcting the positional deviation, this causes a blur in the merged phase distribution. For this reason, when merging phase distributions calculated in two orthogonal shear directions, it is desirable to detect the shift of the image caused by the switching of the shear direction and to correct the position before merging these images.

Meanwhile, the phase distribution calculated by applying a deconvolution process to the structure component is a distribution corresponding to the object structure except for a structure that extends in an approximately vertical direction with respect to the shear direction. For this reason, there is a very high similarity between two phase distributions of the structure component calculated with the switching of the shear direction, compared with the cases of other components (the background component and the refraction component). Using this characteristic, for example, the amount of positional deviation in the images caused by the switching of the shear direction is calculated from the correlation between two phase distributions of the structure component calculated in two shear directions. Then, it is desirable to correct the positional deviation between the two phase distributions of the biological sample calculated in the two shear directions before and after the switching using the calculated amount of positional deviation. Accordingly, blurring in the merged phase distribution may be suppressed. Meanwhile, the correlation may be obtained using the phase-only correlation method, for example. In addition, it is desirable that the correction of the positional deviation caused by the difference in the shear directions, and the merging, are performed between step S7 and step S9 in FIG. 1.

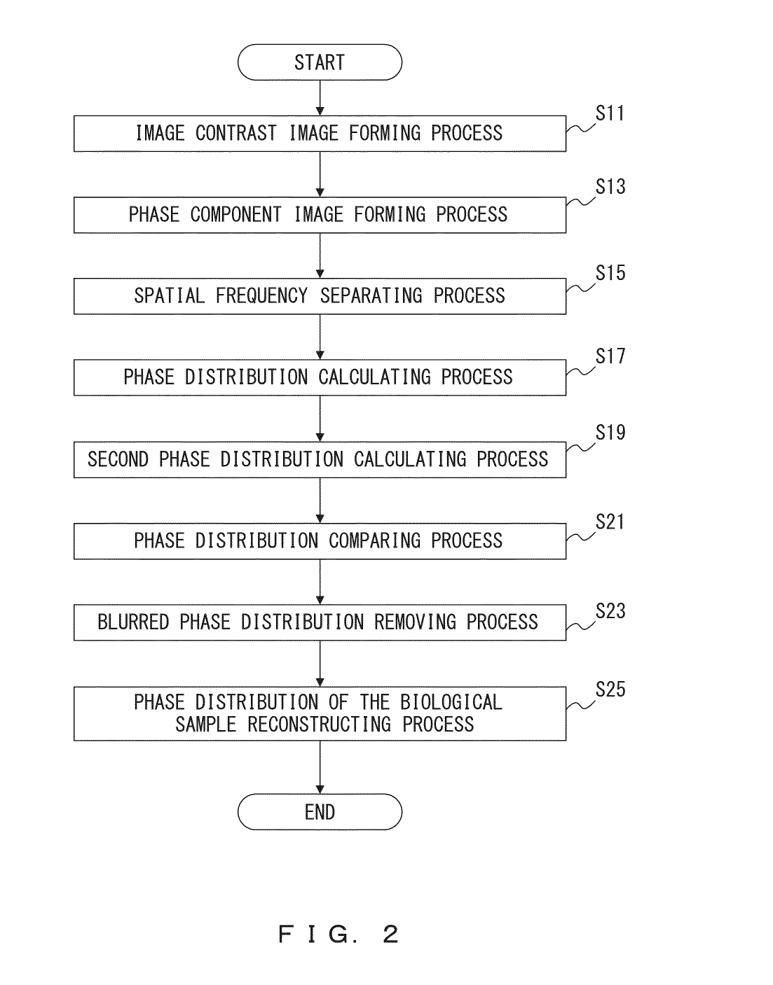

The phase contrast microscope and the differential interference contrast microscope are a microscope with which a biological cell or tissue may be observed without staining, but when the observed object has a complicated three-dimensional structure, blurred images of the biological cell or tissue above and below the observation position enter the observation image. This causes the image intensity distribution to be different from the actual structure at the observation position, making it difficult to study the structure of the biological cell or tissue, and it may become difficult to check mutation or alteration. Hereinafter, a method for improvement in such a problem and to obtain the phase distribution in the observation area of a biological sample with a better accuracy is explained with reference to FIG. 2 through FIG. 7.

The optical response characteristic OTF is generally expressed as MTF·exp (2πi·PTF). Here, MTF is Modulation Transfer Function, and PTF is Phase Transfer Function. When the observed object is on the focal position of the optical system and the optical system is an aberration-free system, PTF=0, and therefore, OTF is equal to MTF and depends only on MTF. However, when the position of the observed object deviates from the focal position of the optical system or when there is an aberration, PTF≠0, and MTF·exp (2πi·PTF) needs to be used as OTF. In Japanese Laid-open Patent Publication No. 9-15504 mentioned above, in order to simplify the explanation, it is assumed that the observed object is on the focal position of the optical system and the optical system is an aberration-free system, and OFT that depends only on MTF is used in performing the deconvolution process.

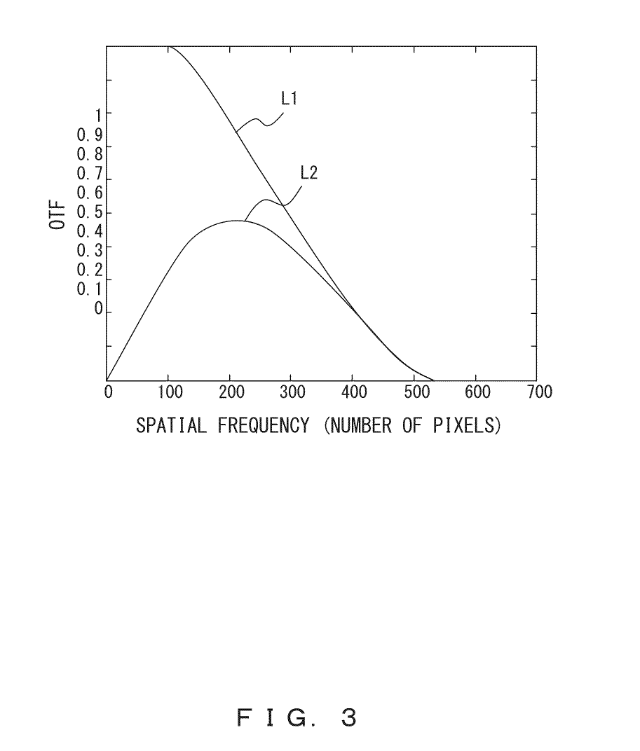

Meanwhile, FIG. 3 is a diagram illustrating OTF of the microscope when the observed object is on the focal position of the optical system and the optical system is an aberration-free system. L1 and L2 illustrated in FIG. 3 respectively represent OTF of a bright field microscope and a differential interference contrast microscope equipped with the same objective and the same condenser lens. Meanwhile, MTF of a bright field microscope is determined by the numerical aperture (hereinafter, referred to as NA) of the objective and the NA of the condenser lens, whereas MTF of a differential interference contrast microscope is determined by the product of MTF of a bright field microscope and sin (πΔf). Here, Δ is the shear amount, and f is the spatial frequency. Such relationship between MTF of a bright field microscope and MTF of a differential interference contrast microscope is described in Japanese Laid-open Patent Publication No. 2008-102294, for example.

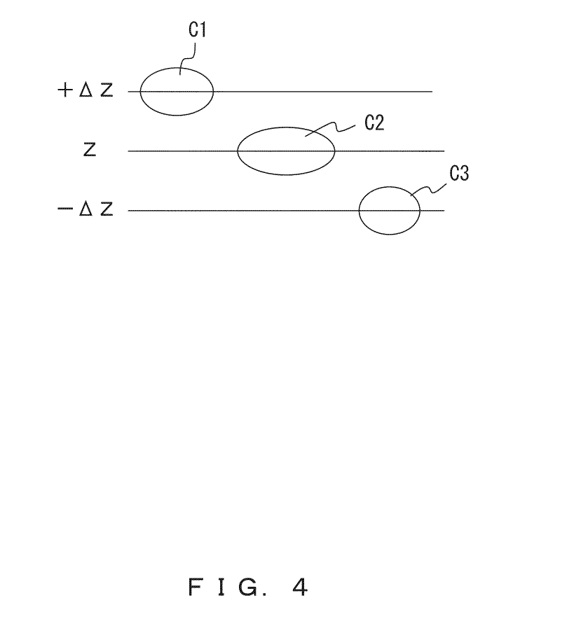

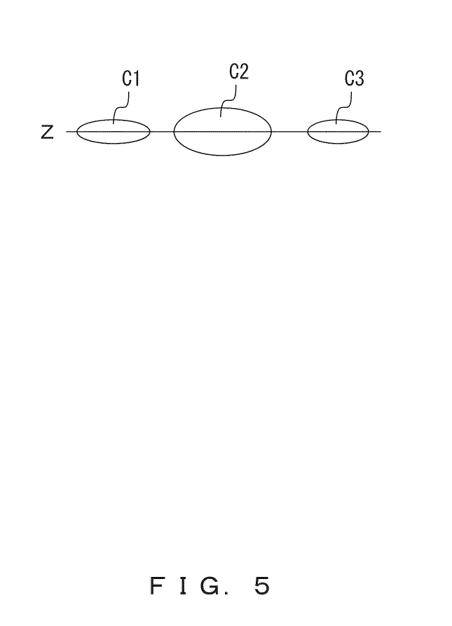

A biological sample that has a three-dimensional structure includes apart (structure C2) positioned on the focal position (Z in FIG. 4) of the observation optical system and apart (structures C1 and C3) positioned on a position (+ΔZ and −ΔZ in FIG. 4) deviated from the focal position. Meanwhile, FIG. 4 is a schematic diagram in which the horizontal direction of the page represents the position of the observed object in a plane vertical to the optical axis at a certain potion in the optical axis direction, and the thickness of the ellipse in the perpendicular direction represents the phase amount. When a deconvolution process is performed using OTF that is dependent only on MTF as in Japanese Laid-open Patent Publication No. 9-15504, the phase distribution corresponding to the part (structure C2) positioned on the focal position is reconstructed as illustrated in FIG. 5. Together with this, the phase distributions of the part (structures C1 and C3) on the position deviated from the focal position is affected by PTF and it is reconstructed with a phase amount smaller than the original phase distribution of the part (structures C1 and C3). This is because the image intensity distribution of the part on a position deviated from the focal position is the image intensity distribution to be obtained by the convolution of the phase distribution and MTF·exp(2πi·PTF) and the deconvolution process is supposed to be performed using MTF·exp(2πi·PTF), but the deconvolution is actually performed using MTF.

Meanwhile, when PTF corresponding to a position deviated from the focal position is calculated and the deconvolution process is performed using MTF·exp(2πi·PTF), the phase distribution corresponding to this part deviated from the focal position is reconstructed. Together with this, the phase distribution of the part positioned on the focal position is affected by PTF and it is reconstructed with a phase amount smaller than the original phase distribution. This is because the image intensity distribution of the part positioned on the focal position is the image intensity distribution to be obtained by convolution of the phase distribution of the part and MTF and the deconvolution process is supposed to be performed using MTF, but the deconvolution process is actually performed using MTF·exp(2πi·PTF). That is, the phase distribution of the part positioned on the focal position becomes equivalent to a phase distribution obtained by convolution of the actual phase distribution and exp(−2πi·PTF), and therefore, it is reconstructed with a small phase amount.

By using this characteristic, the phase distribution of the part (structure C2) on the focal position in the observed object and the phase distribution of the part (structures C1 and C3) on a position deviated from the focal position are separated.

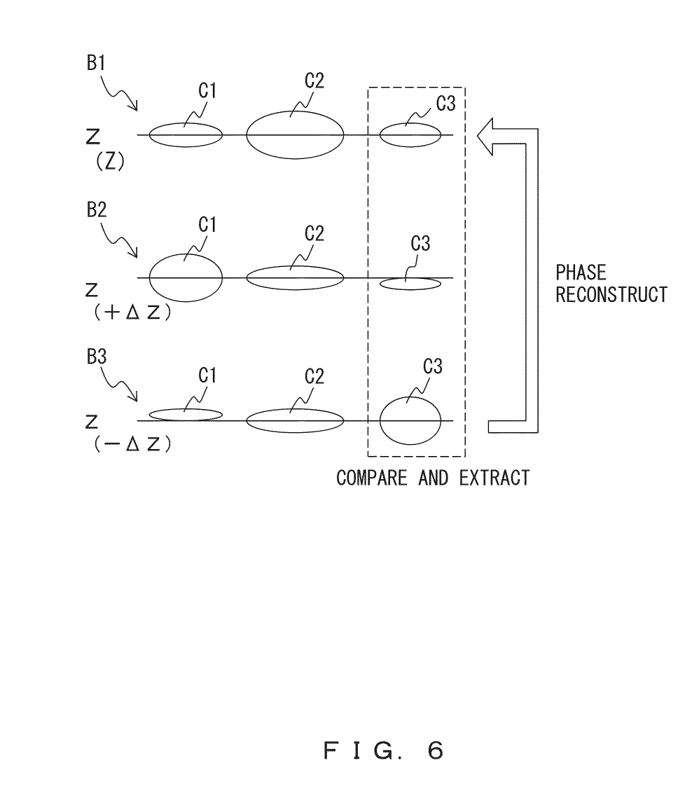

Specifically, first, by the procedures from step S11 through step S17 in FIG. 2, the phase distribution of the refraction component and the phase distribution of the structure component are calculated using OTF in the focused state with respect to the observation plane (the state in which the focal plane of the optical system is positioned on the observation plane) illustrated in FIG. 3. Meanwhile, step S11 through step S17 are processes corresponding to step S1 through step S7 in FIG. 1. In step S17, the phase distribution (phase distribution B1 in FIG. 6) is calculated using OTF in the focused state with respect to the observation plane (that is, MTF).

Next, the second phase distribution (phase distributions B2 and B3 in FIG. 6) of the structure component is calculated by applying a deconvolution process to the structure component obtained in step S15 using OTF in the defocused state with respect to the observation plane (a state in which the focal plane of the optical system is on a position deviated from the observation plane) (step S19 in FIG. 2 (Second phase distribution calculating process)).

Here, OTF in the defocused state is OTF calculated from OTF on the focal position (that is, MTF) and PTF on a position deviated from the focal position (that is, PTF caused by defocusing), and it is MTF·exp(2πi·PTF). The phase distribution B2 in FIG. 6 is the phase distribution of the structure component calculated using OTF at a position deviated from the focal position Z by +ΔZ, and the phase distribution B3 in FIG. 6 is the phase distribution of the structure component calculated using OTF at a position deviated from the focal position Z by −ΔZ. Meanwhile, the phase distribution B1 in FIG. 6 is the phase distribution of the structure component calculated in step S17 using OTF at the focal position Z.

Then, the second phase distribution calculated in step S19 and the phase distribution of the structure component which is the phase distribution in the focused state with respect to the observation plane already calculated in in step S17 are compared (step S21 in FIG. 2 (Phase distribution comparing process)).

As described above, in the phase distribution obtained by deconvolution using OTF in the focused state, the calculated phase amount in the part in the biological sample on the focal position becomes large. In the phase distribution obtained by deconvolution using OTF in the defocused state, the calculated phase amount of a part on a certain position in the biological sample deviated from the focal position becomes large. Using this characteristic, in the comparing process, a binary image is formed in which the part on the focal position is assumed as 1 and a part on a position deviated from the focal position is assumed as 0 on the phase distribution image. Then, according to the binary image, the area deviated from the focal position (for example, the area outside the depth of focus of the microscope) is identified. In the example in FIG. 6, a binary image is formed in which the part where the structure C2 is located is assumed as 1, and the parts where the structures C1 and C3 are located are assumed as 0.

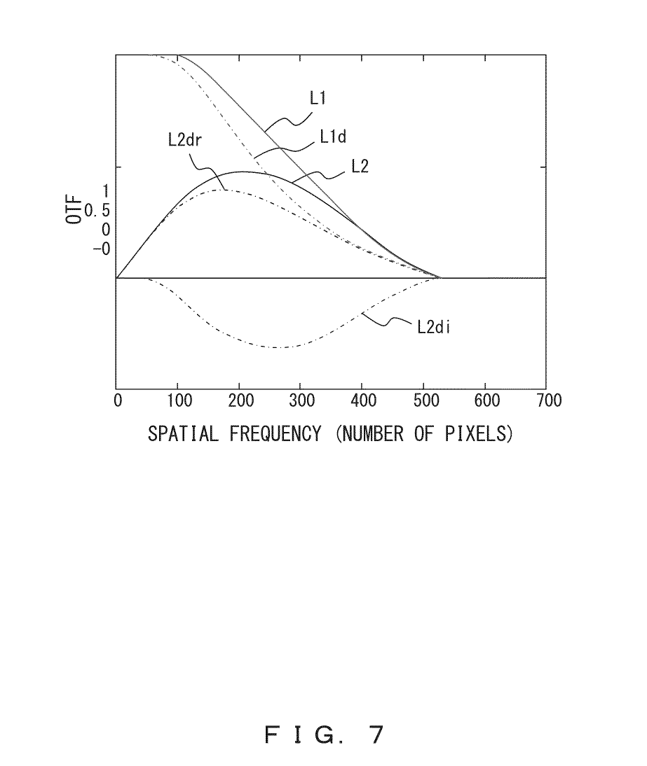

Meanwhile, PTF changes according to the amount of deviation from the focused position (the amount of defocusing), but even with the same amount of defocusing, the influence of PTF on OTF differs depending on the spatial frequency of the object. In FIG. 7, OTF in the focused state is indicated with a solid line, and OTF in the defocused state is indicated with a broken line. More specifically, Lid illustrated in FIG. 7 indicates OTF of a bright field microscope in the defocused state. Meanwhile, L2dr and L2di in FIG. 7 respectively indicate the real part and the imaginary part of the OTF of a differential interference contrast microscope in the defocused state. L1 and L2 in FIG. 7 are OTF of a bright field microscope and a differential interference contrast microscope in the focused state, in a similar manner to FIG. 3.

As illustrated in FIG. 7, the influence of PTF on OTF (that is, the difference between OTF in the focused state and OTF in the defocused state) becomes large in the area in which the spatial frequency of the object is relatively high. For this reason, when forming a binary image by separating the part on the focal position and the part on a position deviated from the focal position, it is desirable to use the structure component with a high spatial frequency, as described above. Accordingly, it becomes possible to make the change in the phase amount with respect to the amount of defocusing larger than in the case of using other components and to increase the sensitivity of the separation.

When the comparing process in step S21 is completed, according to the comparison result, the phase distribution in which defocusing has caused a blur is removed from the phase distribution of the structure component calculated in step S17 (step S23 in step in FIG. 2 (Blurred phase distribution removing process)).

Here, first, the phase distribution of the structure component on a position deviated from the focal position is extracted by obtaining the product of the second phase distribution of the structure component calculated in step S19 and the binary image formed in step S21. After that, the phase distribution of the structure component in which defocusing has caused a blur on the focal position is calculated by applying a convolution process to the extracted phase distribution using OTF in the defocused state. Then, the calculated phase distribution of the structure component having a blur is subtracted from the phase distribution of the structure component calculated in step S17. Accordingly, the phase distribution of the structure component positioned on the focal position is separated and extracted.

Lastly, the phase distribution of the structure component extracted in step S23 and the phase distribution of the refraction component calculated in step S17 are merged, to calculate the phase distribution of the biological sample (step S25 in FIG. 2 (Phase distribution of the biological sample reconstructing process)). Then, a phase distribution image of the biological sample may also be formed from the calculated phase distribution.

By removing the mixed blurred image of the structure positioned above and below the observation position, it becomes possible to recognize the structure at the observation position more accurately. Therefore, according to the method illustrated in FIG. 2, the phase distribution in the observation area may be obtained with a better accuracy, and the three-dimensional structure of a cell or a tissue may be inspected with a better accuracy without staining. In addition, even when the biological sample has a complicated three-dimensional structure, the phase distribution may be reconstructed with a good accuracy. In addition, a phase distribution image that makes it possible to accurately understand the shape and the structure of the biological sample may be formed from the accurate phase distribution of the biological sample.

Meanwhile, in FIG. 2, the expressions “the focal position” and “a position deviated from the focal position” are used for convenience in explanation. It is impossible to separate the phase distribution on a position within the depth of focus from the focal position (the observation plate) because the change in the reconstructed phase distribution is too small with respect to the change in PTF. For this reason, more strictly, according to the method illustrated in FIG. 2, a blurred phase distribution on a position corresponding to the amount of defocusing that is greater than the depth of focus may be separated.

The methods illustrated in FIG. 1 and FIG. 2 are methods in which a plurality of images of a biological sample are captured at a certain Z position in the optical axis direction, the normalized phase component image formed by the images is separated into the background component, the refraction component and the structure component, and the phase of the biological sample is reconstructed from the refraction component and the structure component. Especially the method presented in FIG. 2 is the method for reconstructing the phase distribution from which the influence from the part of the object on a position deviated from the Z position is removed by applying the deconvolution process while changing OTF without changing the Z position. That is, the method presented in FIG. 2 is a method for reconstructing the phase distribution of a biological sample with a specific Z position as the focal position, only from the image obtained at the specific Z position.

Meanwhile, Japanese Laid-open Patent Publication No. 2008-111726 discloses a technique to compare phase distributions reconstructed from normalized phase component images or phase component images at respective Z positions, and to set the Z position at which the contrast of the phase component image becomes the largest or the Z position at which the value of the phase amount of the reconstructed phase distribution becomes the largest as the focal position for the object. The method disclosed in Japanese Laid-open Patent Publication No. 2008-111726 is excellent as a method for detecting the structure of a metal or a silicon wafer surface. However, in this method, the phase distribution on only one Z position is obtained for each pixel. For this reason, when this method is applied without change to an object which has a three-dimensional layers such as a biological cell or tissue, it is impossible to obtain the phase distribution of a biological sample which has a three-dimensional structure.

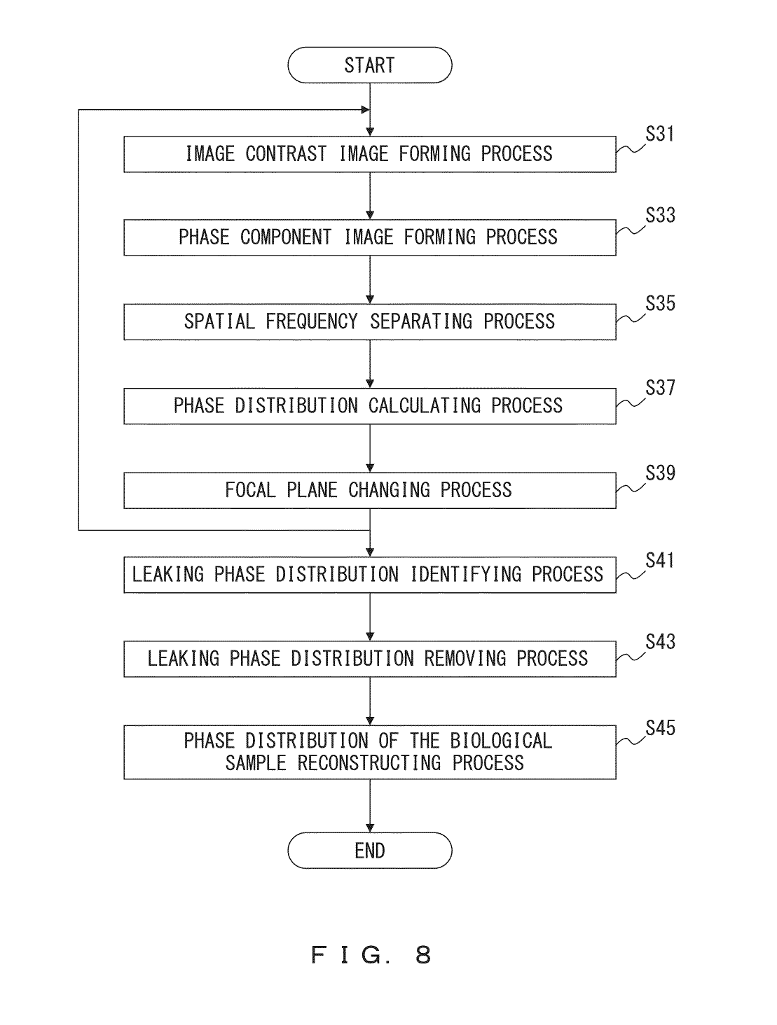

Therefore, hereinafter, a method to reconstruct the phase distribution of a biological sample in which a specific Z position is set as the focal position from images obtained at a plurality of Z positions in order to obtain the phase distribution of a biological sample which has a three-dimensional structure is explained, with reference to FIG. 8.

First, a Z position (that is, the focal plane) is set as the Z position of interest (that is, the observation plane), and the phase distribution of the refraction component and the phase distribution of the structure component are calculated by the procedures of step S31 through step 37 in FIG. 8. Meanwhile, step S31 through step S37 are processes corresponding to step S1 through step S7 in FIG. 1. Meanwhile, in step S37, the phase distribution is calculated using OTF in the focused state with respect to the observation plane illustrated in FIG. 3 (that is, MTF).

Next, the Z position is moved (step S39 in FIG. 8 (Focal plane changing process)). That is, the focal plane of the objective is moved in the optical axis direction with respect to the observation plane. After that, the processes of step S31 through step S37 are performed again. Meanwhile, processes from step S31 through S39 are repeatedly applied at least to a position Z1 which is the Z position of interest, a position Z2 shifted in the positive direction from the position Z1, and a position Z3 shifted in the negative direction from the position Z1. That is, they are applied at least to the Z position of interest and adjacent Z positions above and below the Z position of interest.

After that, the phase distributions of the structure component calculated at the respective Z positions (focal planes) are compared, to identify the phase distribution leaking into the Z position from the structures of the biological sample above and below the Z position (step S41 in FIG. 8 (Leaking phase distribution identifying process)).

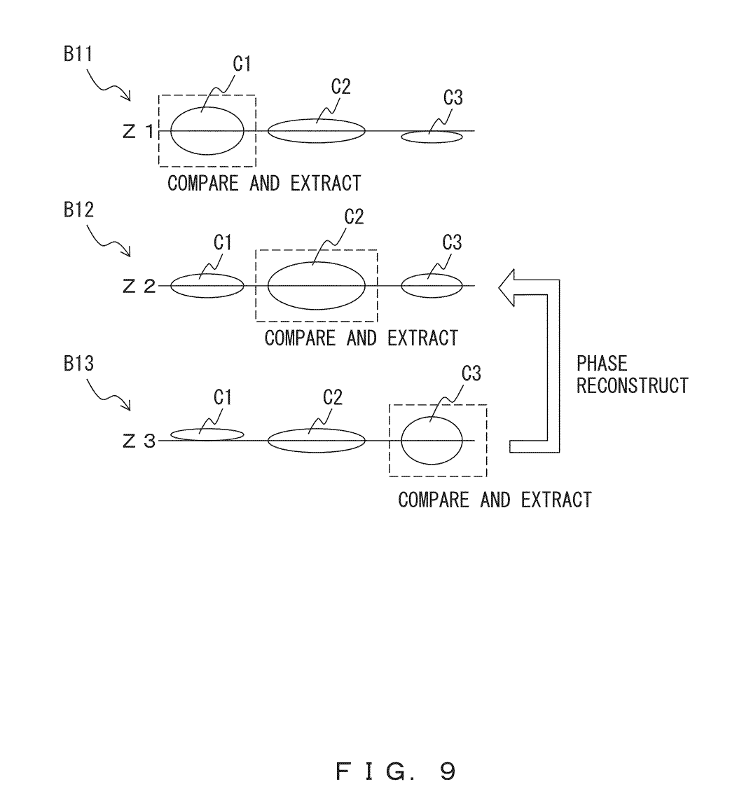

In step S41, first, for each Z position, the area in the XY plane orthogonal to the optical axis in which the phase amount of the structure component at the Z position becomes larger than the phase amount of the structure component at other adjacent Z positions above and below the Z position is extracted as the part for which the Z position is set as the focal position. Here, the phase distribution of the structure component is used because the phase distribution of the structure component has a characteristic that it changes to a larger extent with respect to the amount of defocusing compared with the phase distribution of the refraction component. For this reason, the part on the focal position may be detected more accurately compared with the case in which the phase distribution after the merging which includes the phase distribution of the refraction component is used or the case in which the phase distribution of the refraction component is used. Meanwhile, phase distributions B11, B12, and B13 in FIG. 9 are the phase distributions of the structure component calculated using OTF that is dependent only on MTF (that is, MTF) at the position Z1, the position Z2, and the position Z3, respectively.

In step S41, after that, for each of the Z positions, OTF is calculated in consideration of PTF caused by defocusing between the Z position and the adjacent Z positions above and below the Z position. Then, for each of the Z positions, a convolution process is applied to the phase distribution of the area extracted from the phase distribution of the structure component using OTF calculated in consideration of PTF. Accordingly, the phase distribution detected as a blurred image at the adjacent Z position above and below, in other words, the phase distribution leaking into each of the Z positions from the structures of the biological sample above and below each of the Z positions is identified.

After that, the phase distribution leaking into each of the Z positions identified in step S41 is removed from the phase distribution of the structure component of each of the Z positions (step S43 in FIG. 8 (Leaking phase distribution removing process)). This is realized by subtracting the phase distribution leaking into each of the Z positions from the phase distribution of the structure component of each of the Z positions.

Lastly, the phase distribution of the structure component from which the phase distribution leaking into the Z position calculated in step S43 has been removed and the phase distribution of the refraction structure are merged, to calculate the phase distribution of the biological sample (step S45 in FIG. 8 (Phase distribution of the biological sample reconstructing process)). Furthermore, a phase distribution image of the biological sample may be formed from the calculated phase distribution.

As described above, according to the method presented in FIG. 8, the mixed blurred image of the structure positioned above and below the observation position may be removed, unlike the method presented in Japanese Laid-open Patent Publication No. 2008-111726. For this reason, it becomes possible to recognize the structure at the observation position more accurately. Therefore, according to the method presented in FIG. 8, the phase distribution in the observation area may be obtained with a better accuracy, and the three-dimensional structure of a cell or a tissue may be inspected with a better accuracy without staining. In addition, even when the biological sample has a complicated three-dimensional structure, the phase distribution may be reconstructed with a good accuracy. In addition, a phase distribution image that makes it possible to accurately understand the shape and the structure of the biological sample may be formed from the accurate phase distribution of the biological sample.

The method presented in FIG. 8 may be used together with the method illustrated in FIG. 2, and by using these methods together, it becomes possible to make the influence of the blurred image even smaller. In addition, as described above, according to both the method presented in FIG. 2 and the method presented in FIG. 8, the phase distribution laid over the Z position of interest as a blurred image from a position other than the Z position of interest may be removed, to extract only the phase distribution within the depth of focus. Therefore, the refractive index distribution at each Z position in the biological sample may be obtained by obtaining the depth of focus using calculation or comparison measurement and dividing the phase distribution within the depth of focus by the depth of focus. Furthermore, it is also possible to combine refractive index distributions calculated at respective Z positions to obtain the three-dimensional refractive index distribution.

Meanwhile, a method for removing blurred images of parts focused on different Z positions from the image of the Z position is disclosed in Non-patent document 1 (David A. Agard, Y. Hiraoka, Peter Shaw, John W. Sedat “Methods in Cell biology”, Vol 30(1989)). This method is known as a method for removing fluorescence leaking from a Z position other than the focal position of interest, when using a florescence microscope. In addition, it is also known that this method does not have good affinity with observation methods other than the fluorescence microscopy. This is because in a fluorescence image, the movement of the focus causes a blur in the image according to the movement of the focus, whereas in observation methods other than the fluorescence microscopy, the formed image has a plurality of components, and the change in the image intensity of each component according to the movement of the focus is different. For this reason, it is difficult to apply Non-patent document 1 without change to a microscope such as a differential interference contrast microscope or a phase contrast microscope that converts the image intensity distribution into the phase distribution.

Hereinafter, the method presented in FIG. 8 and the technique of Non-patent document 1 are compared, and similarities and differences between them are explained. First, in the method presented in FIG. 8, a normalized phase component image is formed. The normalized phase component image is an image formed with image signals in which the optical response characteristic is convolved with the phase distribution of the observed object, which has the same characteristics as the image characteristics of the fluorescence microscope. For this reason, the method presented in FIG. 8 and the technique of Non-patent document 1 are similar in terms of image characteristics. Meanwhile, in the method presented in FIG. 8, the normalized phase component image is separated into the respective components of the background, the refraction and the structure. This is because the method presented in FIG. 8 takes it into consideration that the background component is not relevant to the movement of the focus, that that the refraction component is for a phase distribution that changes moderately and is shared among plurality of Z positions, and is subject to the influence of the movement of the focus, and that, for the structure component, the influence of the movement of the focus tends to cause a blurred image laid over different Z positions. In this regard, the method presented in FIG. 8 and Non-patent document 1 are significantly different.

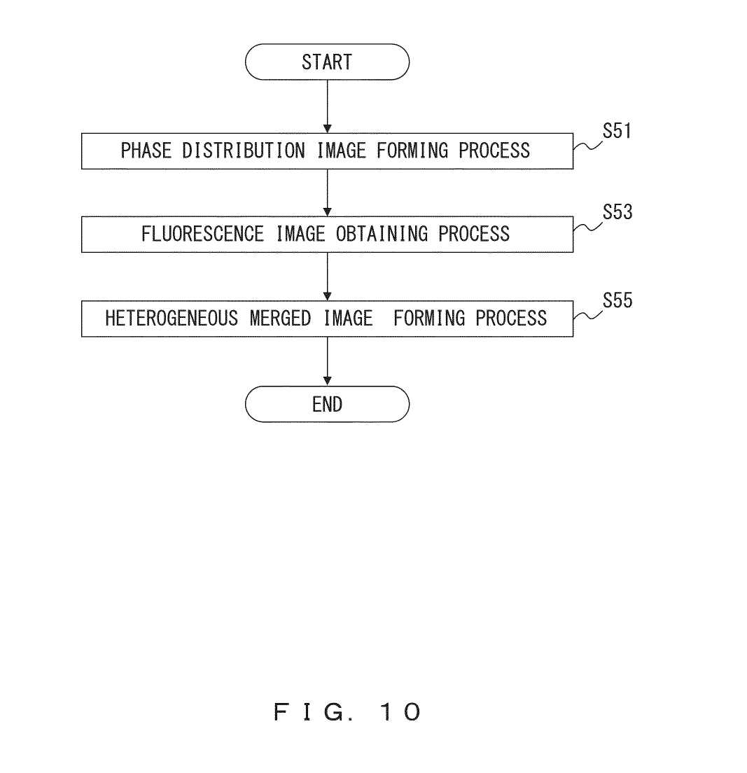

Next, a method for forming a heterogeneous merged image using the phase distribution image of the biological sample formed from the phase distribution of the biological sample calculated using the phase measurement method (also called the phase distribution measurement method) described above is explained with reference to FIG. 10. While FIG. 10 presents a fluorescence image as an example of an image obtained using another observation method which is to be merged with the phase distribution image, any image may be merged with the phase distribution image as long as it is an image in which the biochemical phenomenon and/or the physical phenomenon in the biological sample are visualized.

First, the phase distribution of the biological sample is calculated using the phase measurement method described above (FIG. 1, FIG. 2, FIG. 8 and the like) and a phase distribution image of the biological sample is formed from the calculated phase distribution (step S51 in FIG. 10, (Phase distribution image forming process)).

Next, a fluorescence image of the biological sample is obtained (step S53 in FIG. 10 (Fluorescence image obtaining process)), and lastly, the phase distribution image and the fluorescence image are merged to form a heterogeneous merged image (step S55 in FIG. 10 (Heterogeneous merged image forming process)). Meanwhile, the fluorescence image may be obtained by the same apparatus as that for the phase distribution image, or it may be obtained by another apparatus.

According to the method presented in FIG. 10, the phase distribution image that makes it possible to accurately understand the shape and the structure of the biological sample is used for the merging. Therefore, a heterogeneous merged image that makes it possible to accurately understand the position of a part in the biological sample at which the biochemical phenomenon and/or the physical phenomenon are occurring or the influence of a biochemical phenomenon and/or a physical phenomenon on the shape or the structure of the biological sample may be formed. For example, the state of activity of a protein or the like combined with a fluorescent substance may be understood from the luminance of the fluorescence indicated by the fluorescence image which is a component of the heterogeneous merged image, or from the change in the ratio of FRET (fluorescence resonance energy transfer) indicated by the fluorescence image. The overall shape of the biological sample may be understood from the phase distribution image which is a component of the heterogeneous merged image.

Hereinafter, embodiments of the phase measurement method and the heterogeneous merged image forming method described above are specifically explained. Meanwhile, Embodiment 1 through Embodiment 3 are examples in which an image in which a biochemical phenomenon in a biological sample is visualized is obtained by an apparatus which is different from the apparatus with which the phase distribution image is formed, and Embodiment 4 through Embodiment 9 are examples in which the images are obtained using the same apparatus.

### Embodiment 1

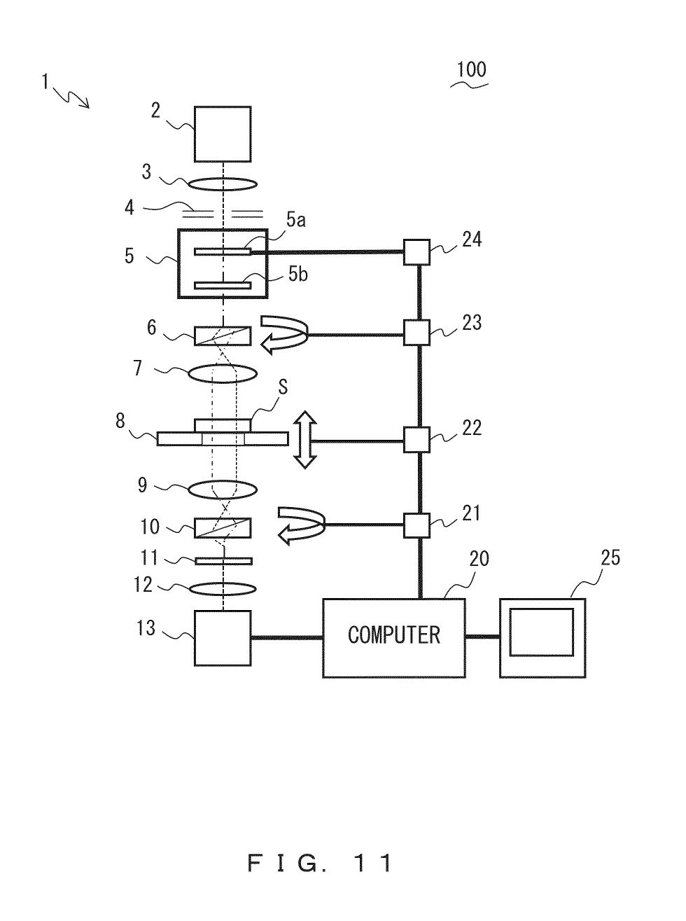

With reference to FIG. 11, the configuration of a phase measurement apparatus that executes the phase measurement methods described above is explained.

A microscope system 100 illustrated in FIG. 11 is a phase measurement apparatus that executes the phase measurement methods described above, and it is an image forming apparatus that forms a heterogeneous merged image by merging a phase distribution image and a fluorescence image. The microscope system 100 includes a microscope 1, a computer 20 that controls the microscope 1, a plurality of driving mechanisms (a driving mechanism 21, a driving mechanism 22, a driving mechanism 23, and a driving mechanism 24) and a monitor 25 that displays the image of a biological sample S.

The microscope 1 is a differential interference contrast microscope that projects the structure of the biological sample S such as a cultured cell on the light receiving plane of an imaging device as the image intensity distribution, and the microscope 1 is configured as an inverted microscope. More specifically, the microscope 1 is equipped with an illumination system, a stage 8, an imaging system, and a CCD camera 13 equipped with an imaging device. Meanwhile, the CCD camera 13 is a two-dimensional detector in which light receiving elements are provided in a two-dimensional arrangement.

The stage 8 is an electric stage on which the biological sample S is placed, and the stage 8 is configured so as to be moved in the optical axis direction by the driving mechanism 22 according to the instruction from the computer 20. The illumination system includes a light source 2, a lens 3, a field stop 4, an image contrast changing unit 5, a Nomarski prism 6, and a condenser lens 7, and the imaging system includes an objective 9, a Nomarski prism 10, an analyzer 11, and a tube lens 12. Here, the numerical aperture (NA) of the condenser lens 7 is 0.55 for example. The objective 9 is a water immersion objective, and the magnification of the objective 9 is 60× for example, and its numerical aperture (NA) is 1.2.

Light emitted from the light source 2 is converted into a linear polarization in the image contrast changing unit 5 that it enters via the lens 3 and the field stop 4, and it is separated into ordinary light and extraordinary light by the Nomarski prism 6, then it is cast on the biological sample S placed on the stage 8 by the condenser lens 7. The ordinary light and the extraordinary light that passed through the biological sample S are merged in the Nomarski prism 10 that they enter via the objective 9, and an image is formed with the merged light on the light receiving plane of the CCD camera 13 by means of. A differential interference contrast image is obtained as described above.

Here, the image contrast changing unit 5 is a phase modulator that has a polarization plate 5a and a λ/4 plate 5b and that uses the Senarmont method in which the rotation of the polarization plate 5a is controlled by the driving mechanism 24 according to the instruction from the computer 20 so as to change the phase of the linear polarization light to convert it into an elliptical polarization light. In the microscope system 100, the computer 20 controls the image contrast changing unit 5 through the driving mechanism 24, so that the image contrast of the image intensity distribution projected on the CCD camera 13 by the microscope 1 may be changed continuously. In addition, the image contrast may also be changed discretely using a stepping motor or the like.

Meanwhile, the Nomarski prism 6 and the Nomarski prism 10 are respectively placed on the pupil position, in the vicinity of the pupil position, its conjugate position, or in the vicinity of its conjugate position of the condenser lens 7 and the objective 9, respectively. In the microscope system 100, the rotation of the Nomarski prism 6 and the Nomarski prism 10 is controlled by the driving mechanism 21 and the driving mechanism 23 according to the instruction from the computer 20 in order to switch the shear direction.

That is, the computer 20 functions as a control unit that controls the CCD camera 13 and the image contrast changing unit 5 so as to obtain a plurality of pieces of images with different image contrasts and that also controls the Nomarski prism 6 and the Nomarski prism 10 so as to switch the shear direction. In addition, the computer 20 is able to move the stage 8 in the optical axis direction through the driving mechanism 22, and therefore, it also functions as a focal position control unit that changes the focal plane in the optical axis direction. Furthermore, as described later, the computer 20 also functions as an operating unit that calculates the phase distribution of the biological sample from the plurality of pieces of images with different contrasts obtained with the control by the computer 20 and that forms the phase distribution image.

Next, the phase measurement method according to the microscope system 100 configured as described above is explained.

First, the computer 20 makes the driving mechanism 21 and the driving mechanism. 23 rotate the Nomarski prism 6 and the Nomarski prism 10, so that the shear direction becomes the 45° direction with respect to the reference direction on the light receiving plane of the CCD camera 13. After that, the computer 20 makes the driving mechanism 24 rotate the polarization plate 5a to change the retardation to ±θ and 0 sequentially to capture, from the CCD camera 13, three differential interference contrast images I1(−θ), I1(0), and I1(θ) with different image contrasts.

Next, the computer 20 makes the driving mechanism 21 and the driving mechanism 23 rotate the Nomarski prism 6 and the Nomarski prism 10 by 90°, so that the shear direction becomes −45° direction with respect to the reference direction on the light receiving plane of the CCD camera 13. After that, the computer 20 makes the driving mechanism 24 rotate the polarization plate 5a to change the retardation to ±θ and 0 sequentially to capture from CCD camera 13 three differential interference contrast images I2(−θ), I2(0), and I2(θ) with different image contrasts.

Meanwhile, the rotation of the polarization plate 5a by the driving mechanism 24 is controlled so as to perform offset correction using a measured value in advance of the deviation in the retardation amount caused with the rotation of the Nomarski prism, so that the retardation caused in the phase modulator (the image contrast changing unit 5) becomes ±θ and 0 regardless of the orientation of the Nomarski prism.

Next, the computer 20 forms a normalized phase component image for each shear direction by performing the following calculations using the obtained differential interference contrast images. Here, Def1 and Def2 are a normalized phase component image.

Def1={I1(θ)−I1(−θ)}/{I1(θ)+I1(−θ)−I1(0)}

Def2={I2(θ)−I2(−θ)}/{I2(θ)+I2(−θ)−I2(0)}

After that, the computer 20 applies an averaging process several times to each of the normalized phase component images Def1 and Def2 using an averaging filter with an averaging area (kernel size) 100×100, to form images BG1 and BG2 of the background component. Then, the images BG1 and BG2 of the background component are subtracted from each of the normalized phase component images Def1 and Def2. To each of images (Def1−BG1) and (Def2−BG2) obtained accordingly from which disturbances such as the irregularity in the field of view and the like have been removed, an averaging process is applied several times using an averaging filter with an averaging area (kernel size) 20×20, to form images GR1 and GR2 of the refraction component. Then, the images BG1 and BG2 of the background component and the images GR1 and GR2 of the refraction component are subtracted from the normalized phase component images Def1 and Def2 to form images ST1 (=Def1−BG1−GR1) and ST2 (=Def1−BG2−GR2) of the structure component.

Next, the computer 20 applies a deconvolution process to the images ST1 and ST2 of the structure component using OTF (L2 in FIG. 3) in the focused state of the differential interference contrast microscope illustrated in FIG. 3, to calculate phase distributions PhS1 and PhS2 of the structure component that represent the fine structure of the object.

Meanwhile, the value of the optical response characteristic (OTF) presented in FIG. 3 nears zero in the band where the frequency is zero and in the band where the frequency is the cutoff frequency. This causes division by zero in the deconvolution process, and therefore, the Wiener method is used to prevent the division by zero. In the images ST1 and ST2 of the structure component, the image component in the band in which the frequency is close to zero is small, and therefore, the calculation error may be made small using the Wiener method.

The computer 20 calculates the amount of relative positional deviation between the images caused by the switching of the shear direction of the Nomarski prism from the phase distributions PhS1 and PhS2 of the structure component. The phase distributions PhS1 and PhS2 of the structure component are phase distributions of the structure component obtained for the same object (the biological sample S) with a change in the shear direction of the Nomarski prism. For this reason, the phase distributions are similar except for the phase distribution with respect to the structure approximately perpendicular to each of the shear directions. Therefore, the amount of the relative positional deviation (δx, δy) between the two images may be obtained by applying the phase-only correlation method to the phase distributions PhS1 and PhS2 of the structure component.

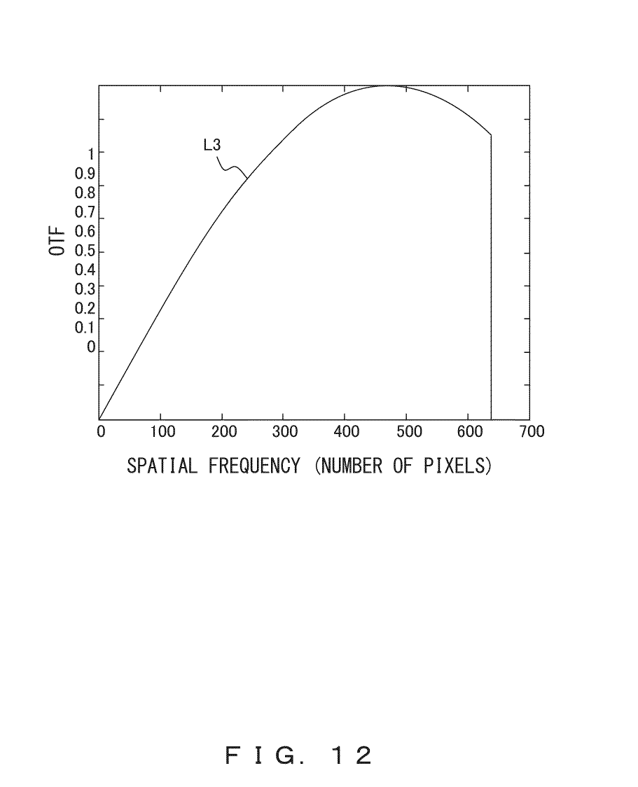

Then, the computer 20 applies a deconvolution process to the images GR1 and GR2 of the refraction component using OTF presented in FIG. 12 instead of OTF presented in FIG. 3 in consideration of the fact that the images GR1 and GR2 of the refraction component have a moderate change in the phase of the sample. Accordingly, phase distributions PhG1 and PhG2 of the refraction component that represent a moderate phase change are calculated.

Meanwhile, OTF (L3 in FIG. 12) corresponding to the refraction component in the focused state is calculated as sin (πΔf) because MTF of the differential interference contrast microscope is the product of MTF of the bright field microscope and sin (πΔf), and the refraction component is a lower frequency component compared with the structure component and under that condition, MTF of the bright field microscope may be regarded as 1 as indicated as L1 in FIG. 3.

When the phase distributions PhS1 and PhS2 of the structure component and the phase distributions PhG1 and PhG2 of the refraction component have been calculated, the computer 20 merges them to calculate phase distributions Ph1 and Ph2 of the observed object (the biological sample S). Meanwhile, the phase distributions Ph1 and Ph2 of the observed object are phase distributions corresponding to the images (Def1−BG1) and (Def2−BG2) of the image intensity distribution from which disturbances such as irregularity in the field of view have been removed, and therefore, they are calculated using the following expressions.

Ph1=PhS1+PhG1

Ph2=PhS2+PhG2

Lastly, in order to eliminate the influence of the shear direction, the phase distributions Ph1 and Ph2 of the observed object obtained in orthogonal shear directions are merged. At this time, the merging is performed after correcting the phase distributions Ph1 and Ph2 using the amounts of the relative positional deviation (δx, δy) between the images. Accordingly, a phase distribution Ph of the biological sample from which the influence of the shear direction has been eliminated may be obtained.

It is expected that, in the phase distribution Ph of a biological sample obtained by the method described above, a blurred phase distribution of a part on a position deviated slightly from the focal position (for example, a position deviated by about ±2 μm) has entered the phase distribution of the part in the vicinity of the focal position (within the depth of focus) of the objective 9. In order to remove such a blurred phase distribution, the computer 20 further performs a calculation as described below.

First, the computer 20 applies a deconvolution process to the images ST1 and ST2 of the structure component using OTF in a state defocused by about 2 μm from the focal plane as illustrated in FIG. 7, to calculate phase distributions PhSd1 and PhSd2 of the structure component.

Next, the computer 20 compares the phase distributions PhSd1 and PhSd2 of the structure component calculated using OTF in the defocused state and the phase distributions PhS1 and PhS2 of the structure component calculated using OTF in the focused state. In the phase distributions PhSd1 and PhSd2 of the structure component calculated using OTF in the state defocused by about 2 μm, the blur in the phase distribution of the object on the defocused position has been reduced, and the phase distribution of the object on the defocused position is calculated as a larger value than in the phase distributions PhS1 and PhS2 of the structure component. In view of this, the part in the vicinity of the focal position and parts on positions deviated from the focal position by about 2 μm are identified, to extract distributions PhSP1 and PhSP2 of the parts on positions deviated from the focal position by about 2 μm.

The computer 20 further applies a convolution process to the extracted phase distributions PhSP1 and PhSP2 using OTF in the defocused state, to calculate phase distributions PhSR1 and PhSR2 in which the blur on the focused position is reconstructed.

Lastly, the computer 20 subtracts the phase distributions PhSR1 and PhSR2 in which the blur is reconstructed from the phase distributions PhS1 and PhS2 of the structure component. Accordingly, the phase distribution of the structure component in the vicinity of the focal position is calculated more accurately.

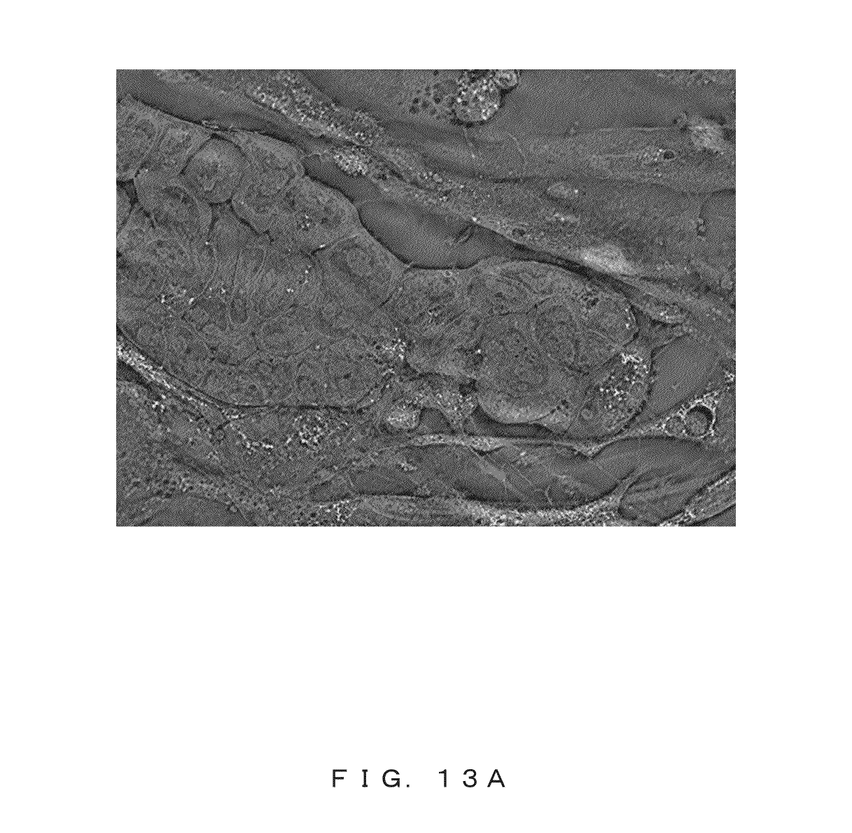

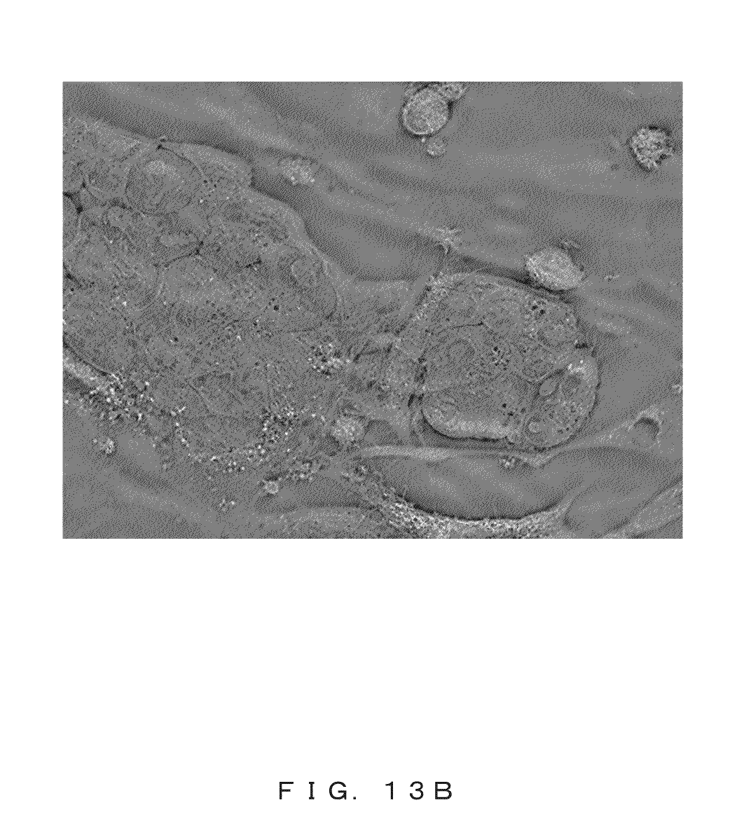

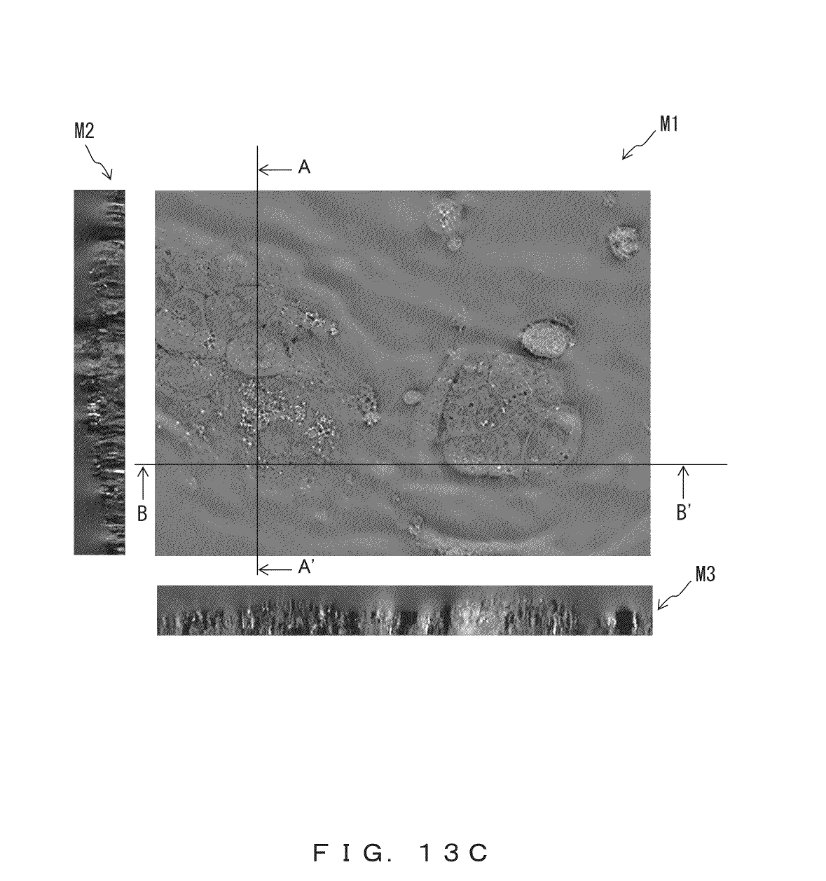

FIG. 13A, FIG. 13B, and FIG. 13C are a part of a plurality of phase distribution images obtained by measuring the phase distribution of iPS cells of a mouse in a culture solution by the microscope system 100 while changing the observation position in a step of 0.5 μm in the optical axis direction. More specifically, the phase distribution of iPS cells of a mouse in a culture solution illuminated with a condenser lens with NA=0.55 is measured using a water immersion objective with 60×, NA=1.2. Meanwhile, FIG. 13A is the phase distribution image measured at the deepest observation position, FIG. 13B is the phase distribution image measured at the observation position located 3 μm above the observation position for FIG. 13A, and FIG. 13C is the phase distribution image measured at the observation position located further 3 μm above the observation position for FIG. 13B. Meanwhile, FIG. 13C presents, in addition to an image M1 viewed from the optical axis direction, an image M2 and an image M3 that are sectional images of A-A′ section and B-B′ section. The images M2 and M3 are images generated from a plurality of phase distribution images obtained with a change in a step of 0.5 μm in the optical axis direction including the images presented in FIG. 13A through FIG. 13C.

In FIG. 13A, the colony of iPS cells is observed in the center part of the image, and other mutated cells are observed in the peripheral area. Furthermore, in the colony of iPS cells, it is also observed that there is a part in which the space between cells constituting the colony is narrow, and a part in which the space between cells is relatively wide.

Furthermore, in FIG. 13B for which the observation position is 3 μm above the observation position for FIG. 13A, the existence of the colony of iPS cells positioned in the center is observed, but the existence of the mutated cells located in the peripheral area in FIG. 13A is not observed. The difference in the thickness of the cell may be recognized according to this difference. In addition, in FIG. 13B, the mutated cells laid over the colony of the iPS cells positioned in the center part are observed, and therefore, it is recognized that a part of iPS cells is mutated and laid over the upper part of the colony. Furthermore, comparing FIG. 13A and FIG. 13B, the shapes of the cells that form the colony of iPS cells are different. Accordingly, it is recognized that cells at different positions in the optical axis in the group of cells forming the colony have been observed.

In FIG. 13C for which the observation position is 3 μm above the observation position for FIG. 13B (that is, the observation position is 6 μm above compared with FIG. 13A), the colony of iPS cells and the mutated cells laid in the upper part of the colony are also observed. In FIG. 13C, the existence of cells that form the colony of iPS cells other than the cells observed in FIG. 13A and FIG. 13B is observed.

As described above, information related to the height of the colony and the thickness of each cell forming the colony may be obtained from the phase distribution images obtained by the microscope system 100, and the state of the cells at the respective positions in the optical axis direction may also be observed. Specifically, referring to FIG. 13A through FIG. 13C, it is understood that the height (thickness) of one cell is several μm or more, not only for the iPS cells but also for the mutated cells.

In addition, it is expected that organelles have a size of μm order, and cells and organelles change continuously. Accordingly, when the phase distribution is measured while changing the observation position, it follows that the phase distributions of cells and organelles is detected continuously in a overlapped manner at a plurality of observation positions. The continuity of the phase distributions measured at the respective observation positions may be determined by obtaining the correlation (similarity) between the phase distribution measured at a certain observation position and the phase distribution measured at observation position in front and behind. Using this continuity, the phase distribution of a cell or an organelle may be accurately obtained by continuously joining the phase distributions measured at a plurality of observation positions. In addition, the relative refraction index distribution of cell or an organelle may also be obtained by dividing the phase distribution by the distance between the observation positions.

As described above, according to the microscope system 100 according to the present embodiment, the accurate phase distribution of the iPS cells may be obtained. Accordingly, from the phase reconstruct result of the iPS cells, the internal structure of the cultured iPS cells may be measured as the phase distribution. That is, a phase distribution image that makes it possible to accurately understand the shape and the structure of the biological sample may be formed. In addition, it is also possible to distinguish the normal cell and the mutated cell inside the colony. Furthermore, it is also possible to identify a non-mutated state of the iPS cells. That is, it is possible to evaluate the state of the cells in the colony (the morphological change of the cells, the change in the colony, the distribution of dead cells, the adhesiveness between the cells), and the degeneration of cells due to mutation. Meanwhile, these apply not only to iPS cells but also to ES cells.

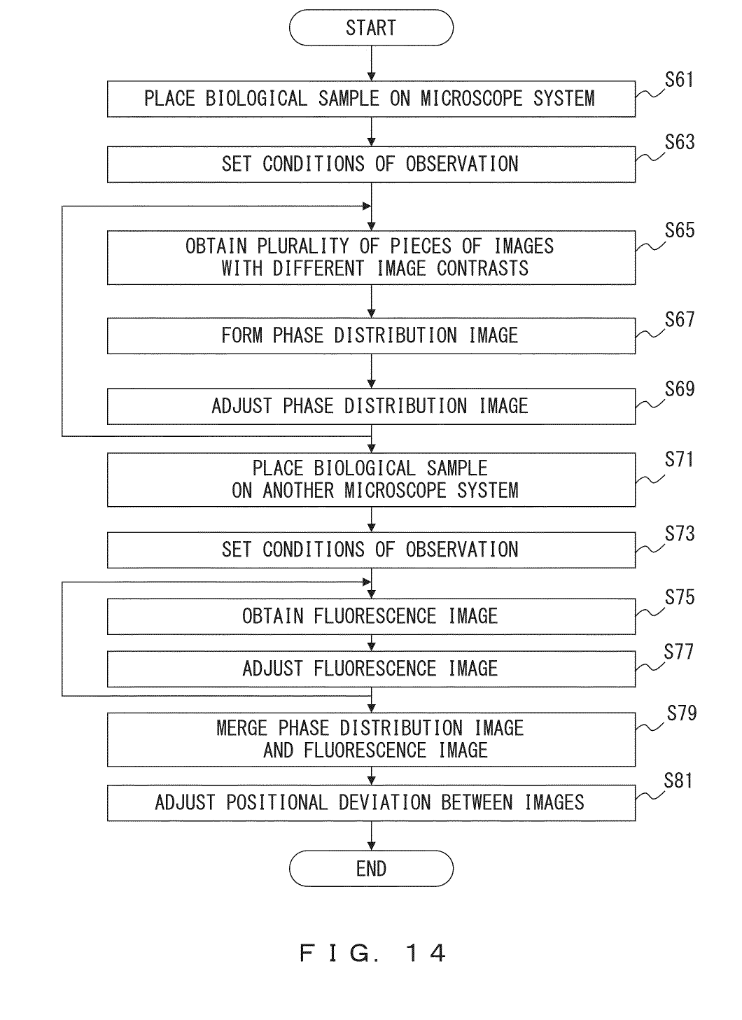

FIG. 14 is a flowchart of a heterogeneous merged image forming method according to the present embodiment. With reference to FIG. 14, a method for forming a heterogeneous merged image by combining a phase distribution image formed by the microscope system 100 described above and a fluorescence image obtained by another microscope system is specifically explained.

First, the user places a biological sample S in the microscope system 100 (step S61 in FIG. 14), and after that, the user sets the conditions of observation (step S63 in FIG. 14). Here, for example, focusing on the biological sample S is performed by adjusting the Z position while observing the biological sample S in a given observation method (such as the bright field observation or the DIC observation), for example. In addition, setting of the parameters of the CCD camera 13 such as the gain, the binning, the exposure time, the illumination intensity and the like, the setting of the parameters of the Z stack, and the setting of the parameters of the time lapse, and the like are performed.

When the setting of the conditions of observation is completed, the computer 20 captures images of the biological sample S multiple times while controlling the image contrast changing unit 5 and the Nomarski prisms (the Nomarski prism 6 and the Nomarski prism 10) through the driving mechanism, to obtain a plurality of pieces of images with different image contrasts (step S65 in FIG. 14). Then, the computer 20 forms a phase distribution image of the biological sample S from the obtained images (step S67 in FIG. 14). Meanwhile, step S65 and step S67 correspond to step S51 in FIG. 10.

When the phase distribution image has been formed, the computer 20 adjusts the phase distribution image (step S69 in FIG. 14). Here, the phase distribution image is adjusted so that the shape and the structure of the biological sample S may be observed well by performing image processing such as adjustment of the luminance. Meanwhile, when blurred images have not been sufficiently removed or the sectioning effect is not sufficiently obtained, the setting of the conditions of observation may be set again and images may be taken again as needed, to form a phase distribution image again.

When the adjustment of the phase distribution image is completed, the Z position is changed to the next position, and the processes in step S65 through step S69 are repeated. This repetition is applied for the number of times determined by the parameters of the Z stack and the parameters of the time lapse set in step S63.

After that, the user places the biological sample S in a microscope system (for example, a confocal fluorescence microscope system) that is different from the microscope system 100 in order to obtain a fluorescence image (step S71 in FIG. 14), and after that, the user sets the conditions of observation (step S73 in FIG. 14). Meanwhile, details of operations in step S73 are similar to those in step S63.

When the setting of the conditions of observation is completed, this different microscope system obtains a fluorescence image of the biological sample S (step S75 in FIG. 14), and then, the fluorescence image is adjusted (step S77 in FIG. 14). Meanwhile, details of operations in step S77 are similar to those in step S69.

When the adjustment of the fluorescence image is completed, the processes in step S75 and step S77 are repeated for the number of times determined by the parameters set in step S73.

After that, the phase distribution image formed by the microscope system 100 and the fluorescence image obtained by the different microscope system are merged to form a heterogeneous merged image (step S79 in FIG. 14). Here, for example, the fluorescence image obtained by the different microscope system is copied to the computer 20 of the microscope system 100, and the computer 20 merges these images. In this case, the computer 20 functions as a merging unit that merges the phase distribution image and the fluorescence image.

When performing the merging, position matching between the images is performed according to the XYZ information (coordinate information) and θ information (angle information) of each of the phase distribution image and the fluorescence image obtained in advance. Furthermore, when the observation magnifications are different, matching of magnifications between the images may be performed according to the magnification information of each. The XYZ information and the magnification information of the phase distribution image are obtained in step S65, for example. The XYZ information and the magnification information of the fluorescence image are obtained in step S75, for example.

Lastly, the positional deviation between the phase distribution image and the fluorescence image that constitute the heterogeneous merged image is adjusted (step S81 in FIG. 14). Here, the user may perform the adjustment while looking at the heterogeneous merged image displayed on the monitor 25, or the computer 20 may automatically adjust the positional deviation. The adjustment of the positional deviation may be performed, for example, using a marker provided in advance in the biological sample for the position matching. The marker is something like a bead that generates a contrast in the phase distribution image and that emits fluorescence. Meanwhile, it may also be something like a dark dot such as a metal particle that does not generate any phase distribution nor fluorescence. In addition, the shape of the marker is not limited to the dot shape, and it may be any shape.

As described above, in the heterogeneous merged image forming method according to the present embodiment, a phase distribution image that makes it possible to accurately understand the shape and the structure of the biological sample is formed first, and then, the formed phase distribution image is merged with a fluorescence image. Accordingly, a heterogeneous merged image that makes it possible to accurately understand the position of a part in the biological sample at which the biochemical phenomenon and/or the physical phenomenon are occurring or the influence of a biochemical phenomenon and/or a physical phenomenon on the shape or the structure of the biological sample may be formed.

Meanwhile, a fluorescence image is presented as an example of an image to be merged with the phase distribution image in FIG. 14, but the image to be merged with the phase distribution image is not limited to the fluorescence image. For example, it may be an image based on light emitted spontaneously and periodically from the biological sample S (for example, light emitted in relation to the circadian rhythm), or an image based on light emission from the biological sample S induced by a chemical injected into the biological sample S, as long as it is an image in which the biochemical phenomenon and/or the physical phenomenon are visualized. In addition, it may be an image obtained by an SHG microscope. In addition, it is not limited to an image based on biochemical light emission, and it may also be an image based on sound waves reflected in the biological sample, a magnetic field, heat distribution, or radiation emitted from the biological sample.

In addition, FIG. 14 presents an example in which the phase distribution image is formed first and the fluorescence image is obtained after that, but the fluorescence image may be obtained first, and the phase distribution may be formed after that. In addition, the phase distribution image may be formed after a plurality of pieces of images with different image contrasts and a fluorescence image are obtained. The method presented in FIG. 14 may be executed with a change in the order as needed.

### Embodiment 2

A heterogeneous merged image forming method according to the present embodiment is similar to the method according to Embodiment 1 except that the phase distribution image is formed in a microscope system 101 instead of the microscope system 100. Therefore, hereinafter, the microscope system 101 is explained, and explanation for others is omitted.

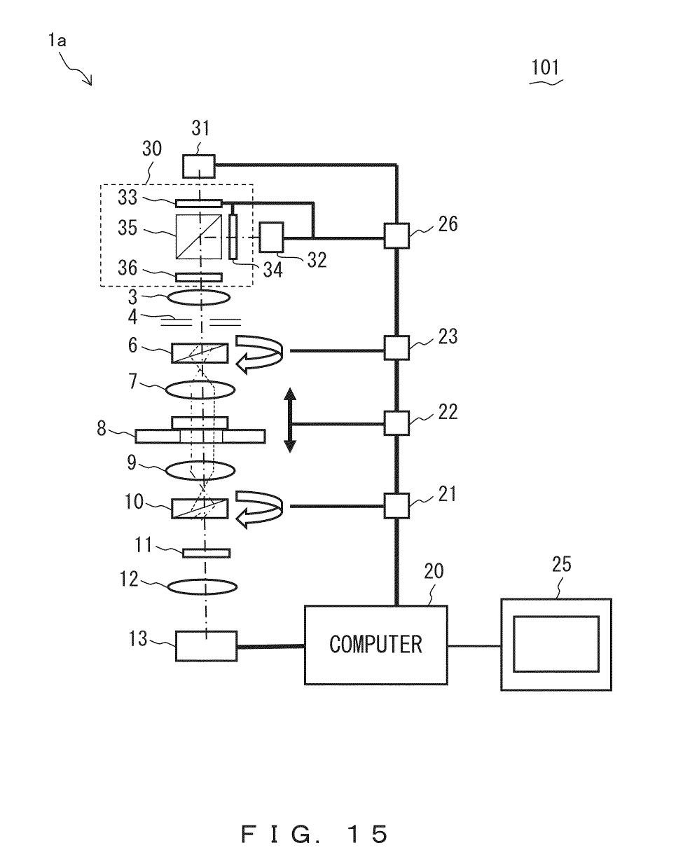

The microscope system 101 illustrated in FIG. 15 is a microscope system equipped with a microscope 1a. The microscope system 101 is a phase measurement apparatus that executes the phase measurement methods described above, and it is an image forming apparatus that forms a heterogeneous merged image by merging a phase distribution image and a fluorescence image, in a similar manner as the microscope system 100 according to Embodiment 1. The microscope system 101 is different from the microscope system 100 according to Embodiment 1 in that the microscope system 101 is equipped with an LED light source 31 and an LED light source 32 instead of the light source 2, a phase modulation unit 30 instead of the image contrast changing unit 5, and a driving mechanism 26 instead of the driving mechanism 24. The other configurations are similar to those of the microscope system 100.

The LED light source 31 and the LED light source 32 are, for example, a single-color LED light source. In the microscope system 101, the computer 20 controls the light emission of the LED light source 31 and the LED light source 32 through the driving mechanism 26.

The phase modulation unit 30 is equipped with two polarization plates (a polarization plate 33 and a polarization plate 34) that are rotatable with respect to the optical axis, a beam splitter 35 that is an optical merging unit that merges light from the LED light source 31 and light from the LED light source 32 and that emits the merged light in the direction of the optical axis of the lens 3, and a λ/4 plate 36 placed with its optic axis oriented toward a prescribed direction. The beam splitter 35 is equipped with a half mirror, for example.

The polarization plate 33 and the polarization plate 34 are placed between the LED light source 31 and the beam splitter 35, and between the LED light source 32 and the beam splitter 35, respectively. The polarization plate 33 and the polarization plate 34 are similar to the polarization plate 5a in FIG. 11 in that their rotation is controlled by the computer 20 through a driving mechanism (here, the driving mechanism 26), and that they respectively function as a phase modulator that uses the Senarmont method together with a λ/4 plate (here, the λ/4 plate 36).

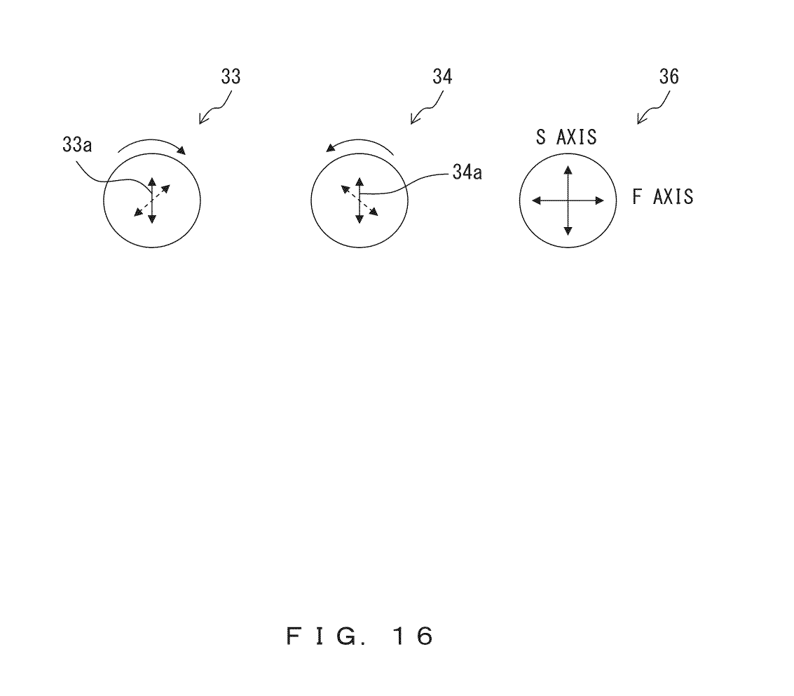

The polarization plate 33 and polarization plate 34 are different from the polarization plate 5a in FIG. 11 in that they are equipped with a structure that is not illustrated in the drawing and that makes the polarization plate 33 and the polarization plate 34 rotate in tandem, and in that they are configured so that a polarizing direction 33a of light passed through the polarization plate 33 and a polarizing direction 34a of light passed through the polarization plate 34 rotate in opposite directions by the same angle with respect to the optic axes (the S axis and the F axis) of the λ/4 plate 36 by means of the structure, as illustrated in FIG. 16.

Furthermore, in the polarization plate 33 and the polarization plate 34, a mechanism to offset the rotation angle of one of the polarization plate 33 and the polarization plate 34 is provided. By means of this mechanism, the rotation angle of one of the polarization plate 33 and the polarization plate 34 is offset so as to compensate the retardation amount generated in the half mirror of the beam splitter 35 or the like.

According to the microscope system 101 configured as described above, in the similar manner as in the microscope system 100 according to Embodiment 1, a phase distribution image that makes it possible to accurately understand the shape and the structure of the biological sample may be formed. Furthermore, in the microscope system 101, in the state in which the polarization plate 33 and the polarization plate 34 are set in given symmetrical rotation angles, the computer 20 makes the LED light source 31 and the LED light source 32 emit light sequentially. Accordingly, two differential interference contrast images (I1(−θ), I1(θ)) with different image contrasts in which the images of the sample S have been captured with different settings for the retardation amount may be obtained. Meanwhile, in the light emission control for the LED light sources, the switching may be made faster than in the rotation control for the polarization plate 5a in the microscope system 100 according to Embodiment 1, and therefore, according to the microscope system 101 according to the present embodiment, the two differential interference contrast images (I1(−θ), I1(θ)) may be obtained quickly. Accordingly, it becomes possible to measure the phase distribution more quickly than in the microscope system 100 according to Embodiment 1.

Meanwhile, in the microscope system 101 according to the present embodiment, unlike the microscope system 100 according to Embodiment 1, only the two differential interference contrast images (I1(−θ), I1(θ)) are obtained without obtaining the differential interference contrast image I1(0). While the differential interference contrast image I1(0) is also used in the phase measurement method described above, the differential interference contrast image 11(0) is used for compensating the error caused in a substance that has a large phase amount. Therefore, it is possible to measure the phase distribution from only the two differential interference contrast images (I1(−θ), I1(θ)).

### Embodiment 3

A heterogeneous merged image forming method according to the present embodiment is similar to the method according to Embodiment 1 except that the phase distribution image is formed by a microscope system 102 instead of the microscope system 100. Therefore, hereinafter, the microscope system 102 is explained, and explanation for others is omitted.

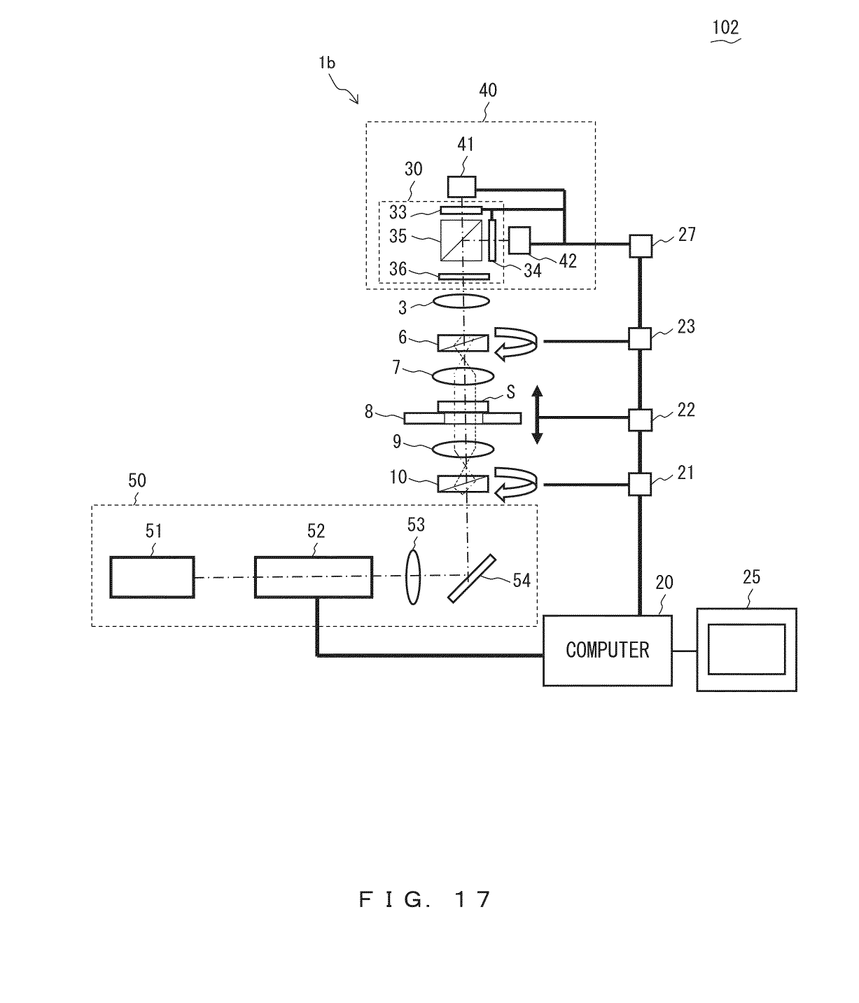

The microscope system 102 illustrated in FIG. 17 is a microscope system equipped with a microscope 1b which is a laser-scanning type differential interference contrast microscope. The microscope system 102 is a phase measurement apparatus that executes the phase measurement methods described above, and that forms a heterogeneous merged image by merging a phase distribution image and a fluorescence image, in a similar manner as the microscopes according to Embodiment 1 and Embodiment 2.

The microscope system 102 is different from the microscope system 100 according to Embodiment 1 in that the microscope system 102 is equipped with the microscope 1b instead of the microscope 1, and a driving mechanism 27 instead of the driving mechanism 24. Furthermore, the microscope 1b is different from the microscope 1 according to Embodiment 1 in that the microscope 1b is equipped with a detecting unit 40 instead of the light source 2, the field stop 4 and the image contrast changing unit 5, and an illuminating unit 50 instead of the analyzer 11, the tube lens 12 and the CCD camera 13. That is, the microscope 1b is configured so as to cast laser light on a biological sample S from below the stage 8 and to detect laser light that passes through the biological sample S.

The illuminating unit 50 is equipped with a laser light source 51, a beam scanning apparatus 52, a relay lens 53, and a mirror 54. The laser light source 51 may be a laser that emits laser light in the visible wavelength region, or may be a laser that emits laser light in the near infrared wavelength region that has a longer wavelength and that is less prone to scattering compared with the visible light. When the sample S is thick, a laser that emits laser light in the near infrared wavelength region is desirable. The beam scanning apparatus 52 is an apparatus for scanning the sample S with laser light emitted from the laser light source 51, and it is equipped with a galvano mirror that deflects laser light at the pupil conjugate position of the objective 9, for example.

The detecting unit 40 is a differential detecting unit equipped with photomultiplier tubes (a PMT 41 and a PMT 42) that are two photodetectors, and a phase modulation unit 30. The phase modulation unit 30 has a similar configuration to that of the phase modulation unit 30 in the microscope 1a according to Embodiment 2. Specifically, the phase modulation unit 30 is equipped with the two polarization plates (the polarization plate 33 and the polarization plate 34) that are rotatable with respective to the optical axis, the beam splitter 35 equipped with a half mirror, and the λ/4 plate 36 placed with its optic axis oriented toward a prescribed direction. Meanwhile, here, the beam splitter 35 functions as a light separating unit that splits laser light from the sample S into two and that guides them to the PMT 41 and the PMT 42.

In a usual differential detecting unit, there are constraints on the setting of the retardation because light is separated by a polarization beam splitter (PBS). By contrast, the differential detecting unit (the detecting unit 40) of the microscope system 102 is different from the usual differential detecting unit in that it is equipped with the polarization plate 33 and the polarization plate 34 configured so that the polarizing directions (the polarizing direction 33a and the polarizing direction 34a) of light passed through the polarization plates (the polarization plate 33, the polarization plate 34) rotate in opposite directions by the same angle with respect to the optic axes (the S axis and the F axis) of the λ/4 plate 36, to make it possible to set the retardation according to the sample.

According to the microscope system 102, in the similar manner as in the microscope system 100 according to Embodiment 1, a phase distribution image that makes it possible to accurately understand the shape and the structure of the biological sample may be formed. Furthermore, in the microscope system 102, the laser light source 51 that emits laser light that has a narrow bandwidth and a high monochromaticity is used as the light source, and therefore, a differential interference contrast image with a large S/N and a high contrast may be obtained. In addition, the narrow bandwidth of laser light also contributes to a higher accuracy of the deconvolution process. For this reason, a more accurate phase distribution may be calculated from the differential interference contrast image. Therefore, according to the microscope system 102, a more accurate phase distribution may be calculated compared with the microscope system 100 according to Embodiment 1.

Meanwhile, when a laser light source is used as the light source in a usual microscope (a wide-field microscope), this causes undesirable phenomena such as a decrease in resolution and occurrence of a speckle due to coherent illumination, but such phenomena do not occur in a scanning type microscope such as the microscope system 102. For this reason, the scanning type microscope is preferable for the use of laser light.

On the other hand, the scanning-type microscope takes a longer time to obtain an image compared with a wide-field microscope, and the time required to calculate the phase distribution also tends to be longer. In this regard, in the microscope system 102, an arrangement to make the calculation of the phase distribution faster is made by obtaining a plurality of images with different image contrasts simultaneously using the differential detecting unit (the detecting unit 40). Specifically, laser light emitted from the laser light source 51 and entered the differential detecting unit (the detecting unit 40) is separated in the beam splitter 35 into laser light that goes to PMT 41 and laser light that goes to PMT 42, and after that, they respectively enter the PMT 41 and PMT 42 via the polarization plate 33 and polarization plate 34 set in symmetrical rotation angles. Accordingly, in the microscope system 102, two differential interference contrast images (I1(−θ), I1(θ)) with different image contrasts in which the images of the sample S have been captured with different settings for the retardation amount may be obtained simultaneously with one scanning of the sample by the beam scanning apparatus 52.

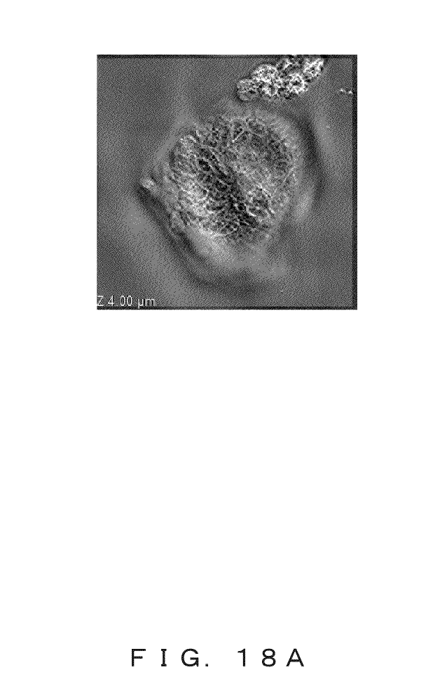

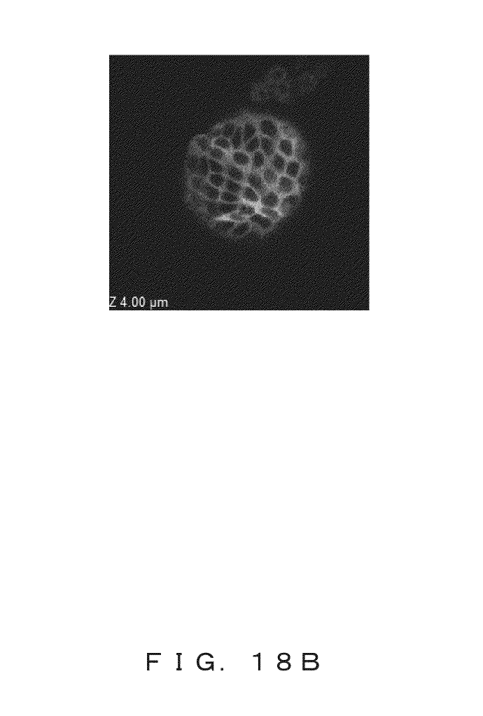

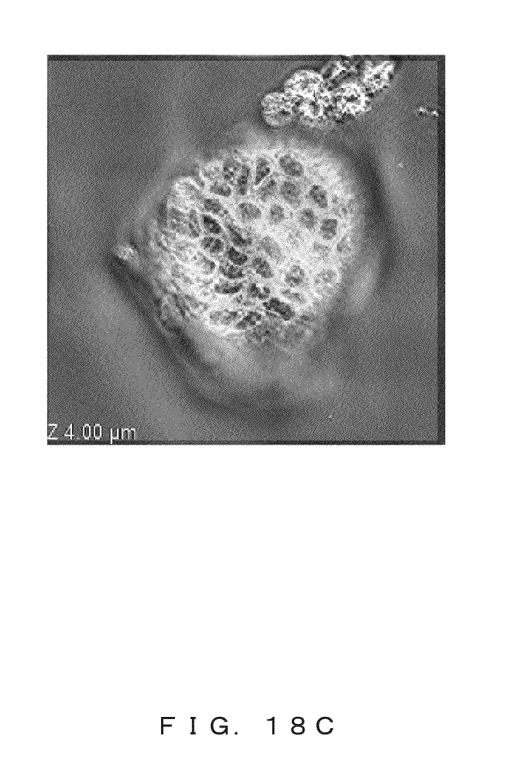

FIG. 18A presents a phase distribution image of a cell of crypt tissue in the small intestine obtained by the microscope system 102. The image of the crypt in the small intestine presented in FIG. 18A represents the three-dimensional structure of the crypt well. Therefore, it is confirmed from FIG. 18A that it is possible to observe the three-dimensional structure of a biological tissue using the microscope system 102, and that, for example, when a mutated cell exists in the tissue, it is possible to identify and observe the mutated cell without labeling. FIG. 18B presents a fluorescence image of the cell of the crypt tissue in the small intestine illustrated in FIG. 18A, and in this image, the amount of GFP expressed in the protein in the cytoplasm is displayed as the fluorescence intensity. Then, FIG. 18C presents an image in which the images presented in FIG. 18A and FIG. 18B are merged.

### Embodiment 4

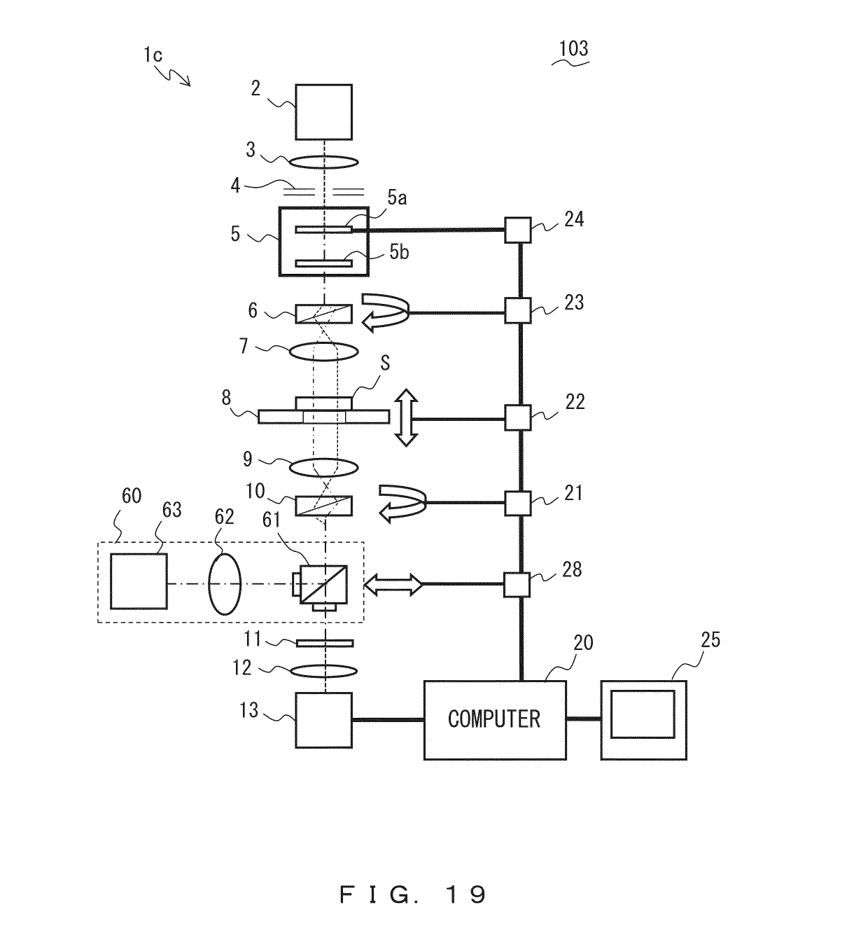

A microscope system 103 illustrated in FIG. 19 is an image forming apparatus that forms a heterogeneous merged image in which a phase distribution image and a fluorescence image are merged. The microscope system 103 is different from the microscope system 100 according to Embodiment 1 in that the microscope system 103 includes a microscope 1c instead of the microscope 1 and that the microscope system 103 includes a driving mechanism 28 that inserts and removes a fluorescence cube 61 described later to and from the optical path. In addition, the microscope system 103 is different from the microscope system 100 also in that the microscope system 103 is capable of obtaining both the fluorescence image and the phase distribution image.

The microscope 1c is different from the microscope 1 according to Embodiment 1 in that the microscope 1c includes, as an illuminating unit 60 for obtaining the fluorescence image, the fluorescence cube 61 placed in a removable manner between the Nomarski prism 10 and the analyzer 11 a lens 62, and a light source 63 for obtaining the fluorescence image. The other configurations are similar to that of the microscope 1. Meanwhile, the microscope 1c is a differential interference contrast microscope, and it is also a fluorescence microscope. In addition, the fluorescence cube 61 includes a dichroic mirror, an excitation filter, and an absorption filter.

When obtaining a fluorescence image by the microscope system 103, the computer 20 inserts the fluorescence cube 61 through the driving mechanism 28 and makes the light source 63 emit light. As a result, the excitation light emitted from the light source 63 is cast on the biological sample S, and fluorescence emitted from the biological sample S enters the CCD camera 13. Accordingly, the microscope system 103 is able to obtain the fluorescence image.

Meanwhile, absorption of fluorescence by the analyzer 11 leads to a decrease in the amount of light of the fluorescence that enters the CCD camera 13. Therefore, it is desirable that the analyzer 11 is removed to the outside of the optical path at the same time with the insertion of the fluorescence cube 61.

When obtaining a phase distribution image by the microscope system 103, the computer 20 removes the fluorescence cube 61 through the driving mechanism 28 and makes the light source 2 emit light. After that, a plurality of pieces of images with different image contrasts are obtained using the method described above in Embodiment 1, to form the phase distribution image.

According to the microscope system 103 configured as described above, in the similar manner as in the microscope system 100 according to Embodiment 1, a phase distribution image that makes it possible to accurately understand the shape and the structure of the biological sample may be formed. Furthermore, in the microscope system 103, a fluorescence image in which a biochemical phenomenon and/or a physical phenomenon in the biological sample are visualized may also be obtained. Therefore, according to the microscope system 103, there is no need to exchange images with another microscope system. For this reason, a heterogeneous merged image in which a phase distribution image and a fluorescence image are merged may be formed more easily than in the microscope system 100 according to Embodiment 1. In addition, the positional deviation between images is less likely to be caused because the phase distribution image and the fluorescence image are obtained by the same microscope.

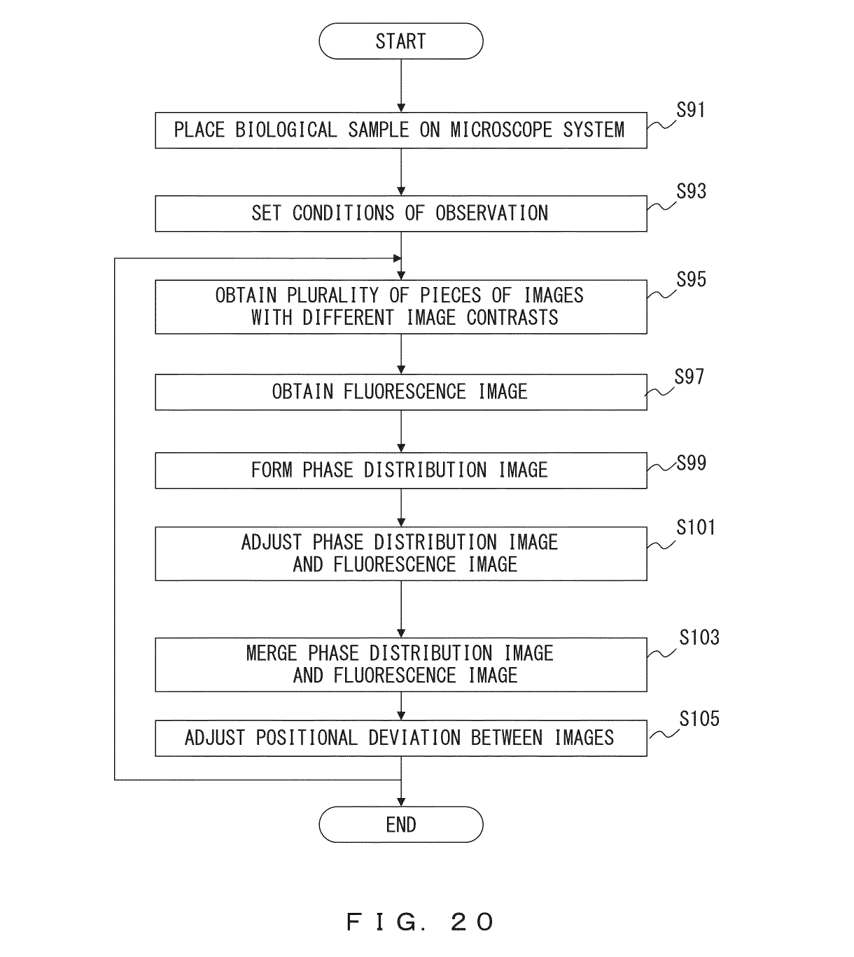

FIG. 20 is a flowchart of a heterogeneous merged image forming method according to the present embodiment. With reference to FIG. 20, the method for forming the heterogeneous merged image executed in the microscope system 103 is specifically explained.

First, the user places a biological sample S in the microscope system 103 (step S91 in FIG. 20), and after that, the user sets the conditions of observation (step S93 in FIG. 20). Here, for example, focusing on the biological sample S is performed by adjusting the Z position while observing the biological sample S in a given observation method (such as the bright field observation, the DIC observation or the fluorescence observation), for example. In addition, setting of the parameters of the CCD camera 13 such as the gain, the binning, the exposure time, the illumination intensity and the like, the setting of the parameters of the Z stack, and the setting of the parameters of the time lapse, and the like are performed. Meanwhile, the setting for these may be different for obtaining the phase distribution image and for obtaining the fluorescence image.

When the setting of the conditions of observation is completed, the computer 20 removes the fluorescence cube 61 from the optical path and makes the light source 2 emit light. Then, images of the biological sample S are taken for a plurality of times while controlling the image contrast changing unit 5 and the Nomarski prisms (the Nomarski prism 6 and the Nomarski prism 10) to obtain a plurality of pieces of images with different image contrasts (step S95 in FIG. 20).

Next, the computer 20 inserts the fluorescence cube 61 into the optical path through the driving mechanism and makes the light source 63 emit light to obtain a fluorescence image (step S97 in FIG. 20). After that, the computer 20 forms a phase distribution image of the biological sample S from the images obtained in step S95 (step S99 in FIG. 20).

When the phase distribution image has been formed, the computer 20 adjusts the phase distribution image and the fluorescence image (step S101 in FIG. 20). Here, the phase distribution image and the fluorescence image are adjusted so that the biological sample S may be observed well by performing image processing such as adjustment of the luminance. Meanwhile, when blurred images have not been sufficiently removed or the sectioning effect is not sufficiently obtained in the phase distribution image, the setting of the conditions of observation may be set again and images may be taken again as needed, to form a phase distribution image again.

When the adjustment of the images is completed, the phase distribution image and the fluorescence image are merged to form a heterogeneous merged image (step S103 in FIG. 20), and then, the positional deviation between the phase distribution image and the fluorescence image that constitute the heterogeneous merged image is adjusted (step S105 in FIG. 20). Here, the user may perform the adjustment while looking at the heterogeneous merged image displayed on the monitor, or the computer 20 may automatically adjust the positional deviation. The adjustment of the positional deviation may be performed, for example, using a marker provided in advance in the biological sample for the position matching.

After that, the Z position is changed to the next position, and the processes in step S95 through step S105 are repeated. This repetition is applied for number of times determined by the parameters of the Z stack and the parameters of the time lapse set in step S93. Meanwhile, in the second execution and the following executions, the adjustment in step S101 and step S105 may be performed by the same adjustment amount as that for in the first execution.

According to the above, a heterogeneous merged image that makes it possible to accurately understand the position of a part in the biological sample at which the biochemical phenomenon and/or the physical phenomenon are occurring or the influence of a biochemical phenomenon and/or a physical phenomenon on the shape or the structure of the biological sample may be formed.

Meanwhile, the microscope system 103 can obtain a plurality of fluorescence images with different fluorescence wavelengths by changing the fluorescence cube 61, and the plurality of fluorescence images and the phase distribution image may be merged to form a heterogeneous merged image. In addition, the microscope system 103 can perform auto-focusing for each time lapse shooting in order to reduce the influence of the drift of the stage 8 due to heat or the influence from vibration. In addition, when a sufficient brightness is obtained, a plurality of pieces of images with different image contrasts may be obtained in the state in which the fluorescence cube 61 is inserted into the optical path to form the phase distribution image. In this case, the influence of chromatic aberration is reduced because light of a prescribed wavelength band in the light emitted from light source 2 is cast on the biological sample S by means of the fluorescence cube 61, and therefore, for some samples, the visibility of the phase distribution image is improved. In addition, a dichroic mirror may be provided between the tube lens 12 and the CCD camera 13, and a CCD camera with a higher sensitivity may be provided on the reflected light path of the dichroic mirror for fluorescence detection.

### Embodiment 5

A heterogeneous merged image forming method according to the present embodiment is similar to Embodiment 4 except that it is executed in a microscope system 105 instead of the microscope system 103. Therefore, hereinafter, microscope system. 105 is explained, and explanation for others is omitted.

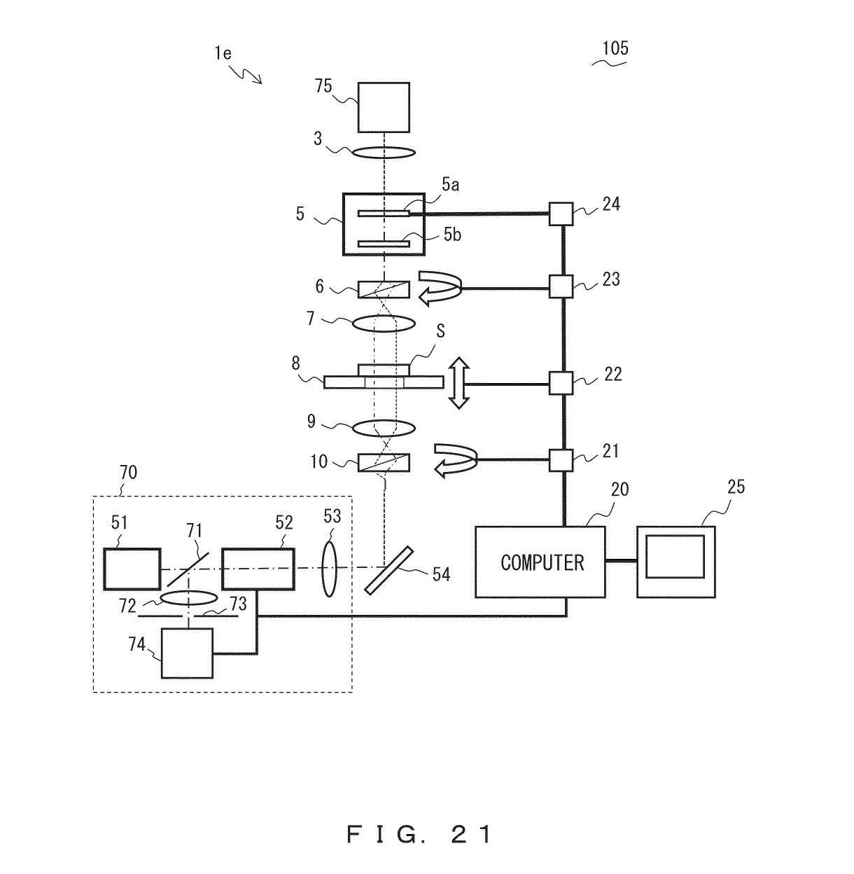

The microscope system 105 illustrated in FIG. 21 is an image forming apparatus that forms a heterogeneous merged image in which a phase distribution image and a fluorescence image are merged, and the microscope system 105 is different from the microscope system 103 according to Embodiment 4 in that the microscope system 105 includes a microscope 1e instead of the microscope 1c, and the microscope system 105 does not include the driving mechanism 28. Meanwhile, the microscope system 105 is similar to the microscope system 103 in that it is capable of obtaining both a fluorescence image and a phase distribution image.

The microscope 1e is a laser-scanning microscope, and the phase distribution image and the fluorescence image are respectively obtained with the scanning of the biological sample S by laser light. The microscope 1e is different from microscope 1c in that the microscope 1e does not include the field stop 4, and that the microscope 1e includes a PMT 75 instead of the light source 2. In addition, the microscope 1e is different from microscope 1c also in that the microscope 1e is equipped with an illuminating and detecting unit 70 and a mirror 54 instead of the analyzer 11, the tube lens 12, the CCD camera 13, and the illuminating unit 60 for obtaining the fluorescence image. The microscope 1e is a differential interference contrast microscope, and it is also a fluorescence microscope.

The illuminating and detecting unit 70 is equipped with a laser light source 51, a beam scanning apparatus 52, a relay lens 53, a dichroic mirror 71, a confocal lens 72, a confocal diaphragm 73, and a PMT 74. The laser light source 51 is, for example, a laser that emits laser light in in the near infrared wavelength region that has a longer wavelength and that is less prone to scattering compared with the visible light. The beam scanning apparatus 52 is a two-dimensional scanning apparatus for scanning the sample S with laser light emitted from the laser light source 51, and it is equipped with a galvano mirror that deflects laser light at the pupil conjugate position of the objective 9, for example. The dichroic mirror 71 has an optical characteristic to transmit laser light and reflect fluorescence.

In the microscope system 105, a plurality of pieces of images with different image contrasts using the phase measurement method described above are obtained by detecting, by the PMT 75, laser light emitted from the laser light source 51 to form a phase distribution image. In addition, a fluorescence image is obtained by detecting, by the PMT 74, the fluorescence from the biological sample S emitted according to the irradiation with laser light emitted from the laser light source 51. Meanwhile, the illuminating and detecting unit 70 is a confocal detecting unit that is equipped with a confocal optical system in which fluorescence emitted from portions other than the focal plane is blocked by the confocal diaphragm 73 and only the fluorescence emitted from the focal plane is detected by the PMT 74.

According to the microscope system 105 configured as described above, in a similar manner as in the microscope system 103 according to Embodiment 4, a heterogeneous merged image that makes it possible to accurately understand the position of a part in the biological sample at which the biochemical phenomenon and/or the physical phenomenon are occurring or the influence of a biochemical phenomenon and/or a physical phenomenon on the shape or the structure of the biological sample may be formed easily.

Furthermore, in the microscope system 105, the laser light source 51 is used as the light source, and therefore, for the reason described above in Embodiment 3, a phase distribution image that represents the phase distribution of the biological sample S more accurately may be formed. In addition, the fluorescence image is obtained using a confocal detecting unit that exhibits the sectioning effect, and therefore, the three-dimensional coordinates of a substance combined with a fluorescent substance may also be understood. Therefore, according to the microscope system 105, it is possible to form a heterogeneous merged image that makes it possible to observe the biological sample S more accurately than in the microscope system 103 according to Embodiment 4. Meanwhile, the microscope system 105 may be equipped with the differential detecting unit 40 illustrated in FIG. 17 for example, and in that case, a plurality of pieces of images with different image contrasts may be obtained through the differential detecting unit 40. In addition, in microscope system 105, a dichroic mirror or a spectroscopic grating may further be provided between the confocal diaphragm 73 and the PMT 74 to obtain a fluorescence image for each wavelength.

### Embodiment 6

A heterogeneous merged image forming method according to the present embodiment is similar to Embodiment 4 except that it is executed in a microscope system 108 instead of the microscope system 103. Therefore, hereinafter, microscope system 108 is explained, and explanation for others is omitted.

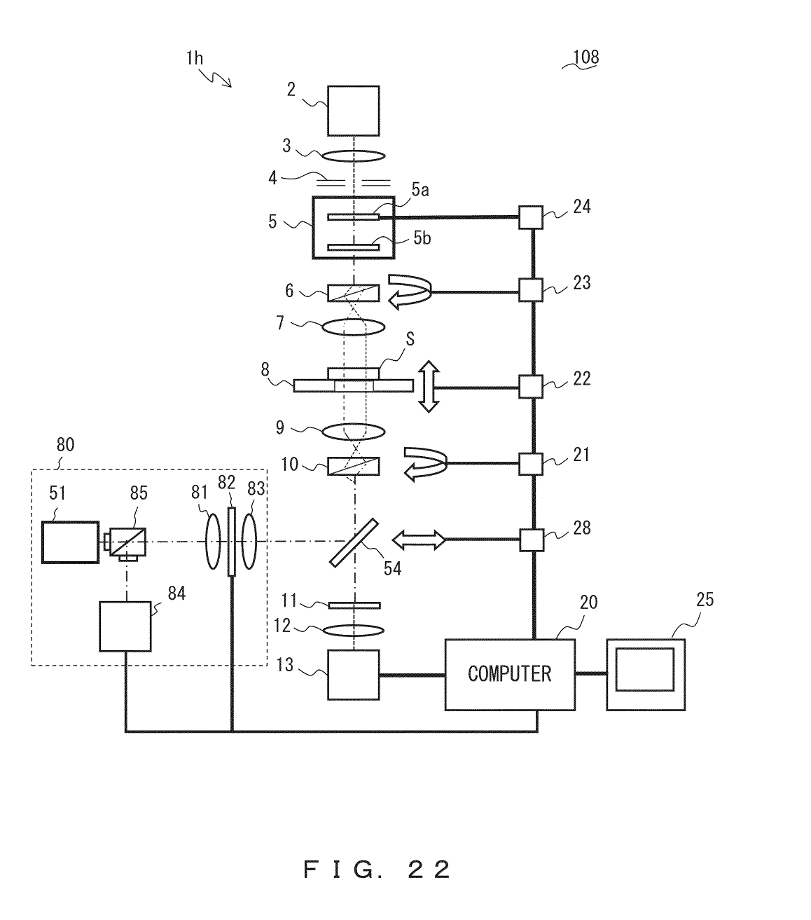

The microscope system 108 illustrated in FIG. 22 is an image forming apparatus that forms a heterogeneous merged image in which a phase distribution image and a fluorescence image are merged, and the microscope system 108 is different from the microscope system 103 in that the microscope system 108 includes a microscope 1h instead of the microscope 1c. Meanwhile, the microscope system 108 is similar to the microscope system 103 in that the microscope system 108 is capable of obtaining both the fluorescence image and the phase distribution image.

The configuration of the microscope 1h for obtaining the fluorescence image is a spinning-disk fluorescence confocal microscope, while the configuration for obtaining the phase distribution image is a wide-field differential interference contrast microscope. The microscope 1h is different from the microscope 1c in that the microscope 1h includes an illuminating and detecting unit 80 and a mirror 54 instead of the illuminating unit 60.

The illuminating and detecting unit 80 is a confocal detecting unit that has a confocal optical system equipped with a laser light source 51, a fluorescence cube 85 that is a mirror unit including a dichroic mirror, a condensing lens 81, a confocal disk 82, a condensing lens 83, and a CCD camera 84. The confocal disk 82 is, for example, a rotating disk such as a Nipkow disk or a slit disk.

In microscope system 108 also, the mirror 54 is inserted into the optical path through the driving mechanism 28 to obtain the fluorescence image, and the mirror 54 is removed from the optical path to obtain the phase distribution image.

According to the microscope system 108 configured as described above, in a similar manner as in the microscope system 103 according to Embodiment 4, a heterogeneous merged image that makes it possible to accurately understand the position of a part in the biological sample at which the biochemical phenomenon and/or the physical phenomenon are occurring or the influence of a biochemical phenomenon and/or a physical phenomenon on the shape or the structure of the biological sample may be formed easily. In addition, the fluorescence image may be obtained using a unit that exhibits the sectioning effect with a spinning disk (the confocal disk 82). For this reason, the three-dimensional coordinates of a substance combined with a fluorescent substance may also be understood. Furthermore, in the microscope system 108, the fluorescence image is obtained by the CCD camera 84 that is a two-dimensional photodetector, the fluorescence image which is a scanned image may be obtained at a high speed.

### Embodiment 7

The heterogeneous merged image forming method according to the present embodiment is similar to Embodiment 4 except that it is executed in a microscope system 110 instead of the microscope system 103. Therefore, hereinafter, microscope system 110 is explained, and explanation for others is omitted.

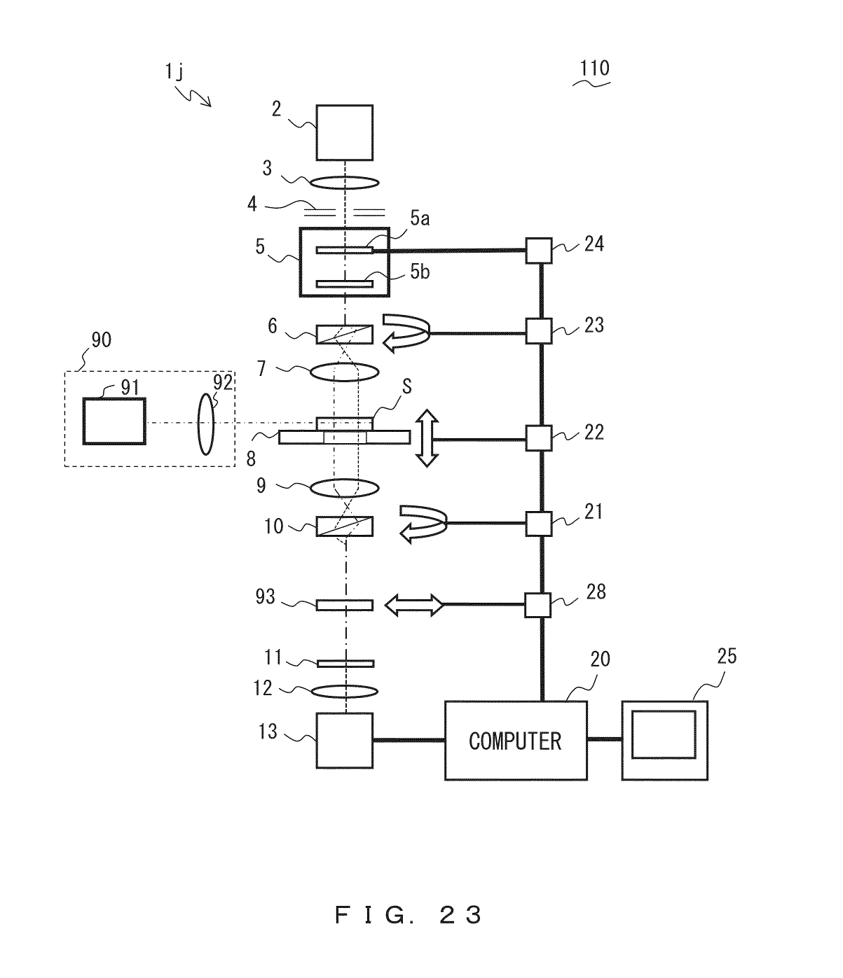

The microscope system 110 illustrated in FIG. 23 is an image forming apparatus that forms a heterogeneous merged image in which a phase distribution image and a fluorescence image are merged, and the microscope system 110 is different from the microscope system 103 in that the microscope system 103 includes a microscope 1j instead of the microscope 1c. Meanwhile, the microscope system 110 is similar to the microscope system 103 in that it is capable of obtaining both a fluorescence image and a phase distribution image.

The microscope 1j is different from the microscope 1c in that the microscope 1j includes alight sheet illuminating unit 90 and that the microscope 1j includes a wavelength selecting filter 93 placed in an exchangeable manner between the Nomarski prism 10 and the analyzer 11 instead of the illuminating unit 60. The microscope 1j is a differential interference contrast microscope, and it is also a fluorescence microscope.

The light sheet illuminating unit 90 includes a laser light source 91 and a lens 92. The lens 92 is, for example, a cylindrical lens. The light sheet illuminating unit 90 is configured so as to convert laser light emitted from the laser light source 91 into a sheet-like laser light (i.e. light sheet) and to irradiate the biological sample S from the lateral side in a sheet-like manner.

When obtaining a fluorescence image by the microscope system 110, the computer 20 changes the wavelength selecting filter 93 through the driving mechanism 28 to a filter that transmits fluorescence and makes the laser light source 91 emit light. Then, the fluorescence image is obtained by detecting, by the CCD camera 13, the fluorescence emitted from the biological sample S according to the irradiation with laser light in a sheet-like manner from the light sheet illuminating unit 90.

When obtaining a phase distribution image by the microscope system 110, the computer 20 changes the wavelength selecting filter 93 through the driving mechanism 28 to a filter that transmits light of the light source wavelength and makes the light source 2 emit light. After that, a plurality of pieces of images with different image contrasts are obtained using the method described above in Embodiment 1, to form the phase distribution image.

According to the microscope system 110 configured as described above, a similar effect to that of the microscope system 103 according to Embodiment 4 may be obtained. In addition, the fluorescence image is obtained using the light sheet illuminating unit that exhibits the sectioning effect, and therefore, the three-dimensional coordinates of a substance combined with a fluorescent substance may also be understood. Therefore, according to the microscope system 110 according to Embodiment 4, a heterogeneous merged image that makes it possible to observe the biological sample S more accurately than in the microscope system 103 according to Embodiment 4 may be formed.

Meanwhile, in the microscope system 110, a plurality of CCD cameras may be provided and the microscope system 110 may be configured to obtain the phase distribution image and the fluorescence image by different CCD cameras. In addition, the microscope system 110 may merge a dark field image instead of the fluorescence image with the phase distribution image. The dark field image may be obtained by illuminating, by the light sheet illuminating unit 90, a biological sample S labeled by injecting metal colloidal particles and by detecting scattered light from the biological sample S by the CCD camera 13.

### Embodiment 8

A heterogeneous merged image forming method according to the present embodiment is similar to Embodiment 4 except that it is executed in a microscope system 111 instead of the microscope system 103. Therefore, hereinafter, microscope system 111 is explained, and explanation for others is omitted.

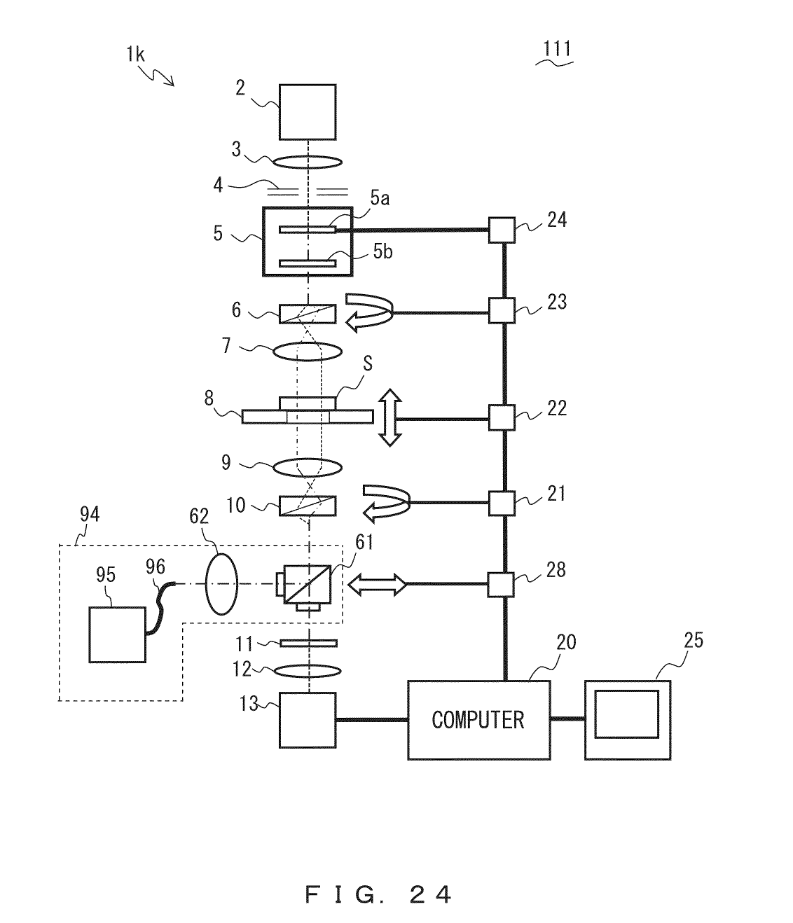

The microscope system 111 illustrated in FIG. 24 is an image forming apparatus that forms a heterogeneous merged image in which a phase distribution image and a fluorescence image are merged, and the microscope system 111 is different from the microscope system 103 according to Embodiment 4 in that the microscope system 111 includes a microscope 1k instead of the microscope 1c. Meanwhile, the microscope system 111 is similar to the microscope system 103 in that the microscope system 111 is capable of obtaining both the fluorescence image and the phase distribution image.

The microscope 1k is different from the microscope 1c in that the microscope 1k includes an illuminating unit 94 that is a total internal reflection illuminating unit. The illuminating unit 94 is different from the illuminating unit 60 in that the illuminating unit 94 includes an optical fiber light source composed with a laser light source 95 and an optical fiber 96, instead of the light source 63. The emitting end of the optical fiber 96 is placed at a position out of the optical axis of the lens 62. Therefore, laser light emitted from the optical fiber light source enters, in parallel to the optical axis, a position out of the optical axis of the lens 62, and the laser light is emitted from the objective 9 at a large angle. Accordingly, the laser light is totally reflected on the biological sample S, and the biological sample S is excited by evanescent light. The microscope 1k is a differential interference contrast microscope, and it is also a Total Internal Reflection Fluorescence microscope (TIRFM).

According to the microscope system 111 configured as described above, a similar effect to that of the microscope system 103 according to Embodiment 4 may be obtained. A conventional Total Internal Reflection Fluorescence microscope is capable of obtaining only the image of the sample near the cover glass, and it is difficult to understand the overall shape of the sample. By contrast, according to the microscope system 111, it is possible to understand the overall shape of the sample, because the phase distribution image and the fluorescence image are merged. Meanwhile, in the microscope system 111, a plurality of CCD cameras may be provided and the microscope system 111 may be configured to obtain the phase distribution image and the fluorescence image by different CCD cameras. In addition, when a sufficient brightness is obtained, a plurality of pieces of images with different image contrasts may be obtained in the state in which the fluorescence cube 61 is inserted into the optical path, to form the phase distribution image. In this case, the influence of chromatic aberration is reduced because light of a prescribed wavelength band in the light emitted from light source 2 is cast on the biological sample S by means of the fluorescence cube 61, and therefore, for some samples, the visibility of the phase distribution image is improved.

### Embodiment 9

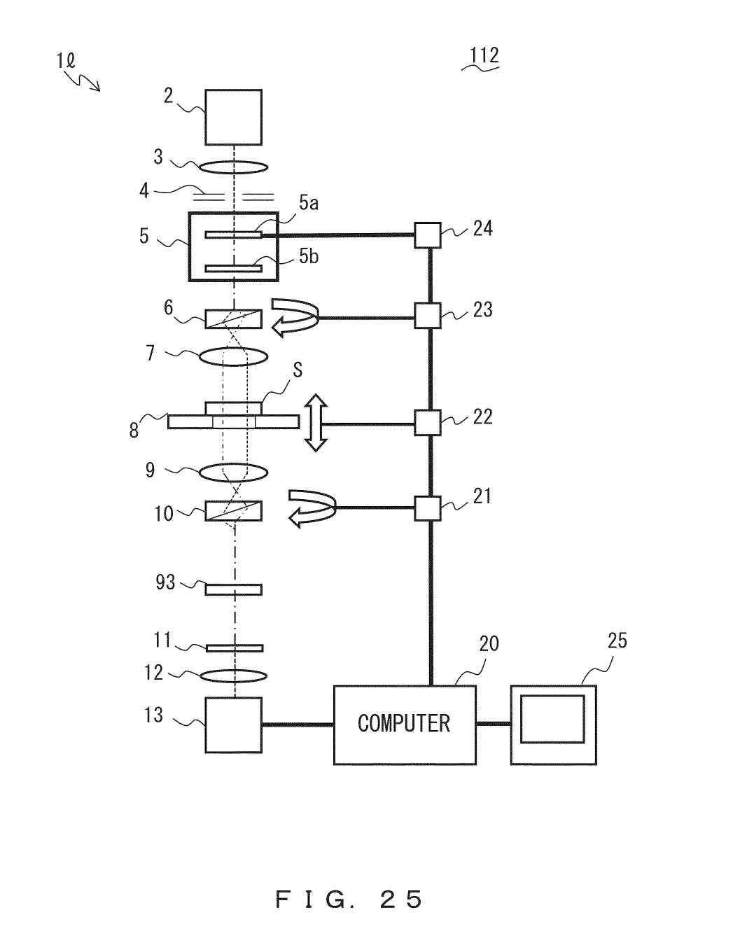

A microscope system 112 illustrated in FIG. 25 is different from microscope system 100 according to Embodiment 1 in that the microscope system 112 is an image forming apparatus that forms a heterogeneous merged image in which a phase distribution image and a light emission image based on light emitted from the biological sample S are merged, and that the microscope system 112 includes a microscope 1l instead of the microscope 1. In addition, the microscope system 112 is different from the microscope system 100 also in that the microscope system 112 is capable of obtaining both the light emission image and the phase distribution image.

Meanwhile, the light emission image is an image based on light emitted spontaneously and periodically from the biological sample S (for example, light emitted in relation to the circadian rhythm), or an image based on light emission from the biological sample S induced by a chemical injected into the biological sample S.

The microscope 1l is different from the microscope 1 in that the microscope 1l includes a wavelength selecting filter 93 that selectively transmits the light which has a given wavelength and which has emitted from the biological sample S.

In the microscope system 112, light emitted from the light source 2 is detected by the CCD camera 13, and a plurality of pieces of images with different image contrasts are obtained using the phase measurement method described above, to form the phase distribution image. In addition, the light emission image is obtained by detecting light emitted from the biological sample S by the CCD camera 13.

Meanwhile, the wavelength to be detected by the CCD camera 13 is limited by obtaining the plurality of pieces of images with different image contrasts through the wavelength selecting filter 93. Accordingly, it is possible to form a phase distribution image in which the influence of chromatic aberration is suppressed. In addition, there is a possibility that when obtaining a plurality of images with different image contrasts, light emitted from the biological sample S is detected at the same time, but light emitted from the biological sample S is weak, and therefore, its influence on the phase distribution image is limited.

According to the microscope system 112 configured as described above, in a similar manner as in the microscope system 100 according to Embodiment 1, a phase distribution image that makes it possible to accurately understand the shape and the structure of the biological sample may be formed. Furthermore, the microscope system 112 is also capable of obtaining a light emission image in which in which the biochemical phenomenon and/or the physical phenomenon are visualized. Therefore, according to the microscope system 112, a heterogeneous merged image in which a phase distribution image and a light emission image are merged may be formed easily.

The embodiments described above present specific examples of the present invention to facilitate understanding of the invention, and the present invention is not limited to these embodiments. For example, in the embodiments described above, a microscope system equipped with the configuration of a differential interference contrast microscope is used, but the microscope included in the microscope system is not necessarily limited to the one which has the configuration of a differential interference contrast microscope, as long as it has the configuration of a microscope that converts the image intensity distribution into the phase distribution. Japanese Laid-open Patent Publication No. 7-225341 discloses a technique to change the image contrast by changing the phase amount of the phase plate of a phase contrast microscope to form a normalized phase component image. A microscope system equipped with a phase contrast microscope using this technique may also be used.

In addition, as indicated in the embodiments described above, the microscope system may be either a wide-field microscope system or a scanning-type microscope system. In addition, any light source may be used as the light source, and for the microscope system, either coherent illumination or incoherent illumination may be used.

In addition, the embodiments described above present examples in which the methods presented in FIG. 1 and FIG. 2 are executed, but the method presented in FIG. 8 may also be executed. In addition, Japanese Laid-open Patent Publication No. 2012-73591 discloses a microscope in which oblique illumination is used, and the image contrast may be changed by changing the direction of the illumination. This may also be used to obtain a similar effect.

In addition, the microscope system may be an observation apparatus equipped with a distinction processing apparatus that distinguishes the normal cell and the cell that has been mutated (a mutated cell) by image processing using the calculated phase distribution of the biological sample. In this case, the observation apparatus may display the mutated cell with distinction from other cells, when displaying the refraction index distribution for each part or the phase distribution of the biological sample on the monitor 25 or the like. In addition, the distinction processing apparatus may distinguish the mutated cell according to the shape of the cell (when the shape is different from that of other cells, for example), the size (when a protrusion exists in the outline of the cell, for example), brightness (when the cell is brighter or darker than other cells, for example), and the like.

For the image forming methods and the image forming apparatuses according to the present invention, various modifications and changes may be made without departing from the spirit of the present invention defined in the claims. As is apparent from the images presented in FIG. 13A through FIG. 13C and FIG. 18A through FIG. 18C, according to the present invention, any biological sample from the cell level to the tissue level (including a tissue formed by the mutation of iPS cells, ES cells or stem cells) may be observed, and the position of a part in the biological sample at which the biochemical phenomenon and/or the physical phenomenon are occurring or the influence of a biochemical phenomenon and/or a physical phenomenon on the shape or the structure of the biological sample may be accurately understood.

What is claimed is:

1. An image forming method for a biological sample, comprising:
capturing optical images of a biological sample formed by a microscope that converts a phase distribution into an image intensity distribution while changing an image contrast, to form a plurality of pieces of images with different image contrasts;
calculating a component corresponding to a phase distribution of the biological sample and a component corresponding to a matter other than the phase distribution of the biological sample according to the plurality of pieces of images, and forming a normalized phase component image by dividing the component corresponding to the phase distribution by the component corresponding to the matter other than the phase distribution of the biological sample;
separating the phase component image into a plurality of frequency components according to spatial frequencies of the image;
applying a deconvolution process to each of the frequency components using an optical response characteristic corresponding to each, to calculate a phase distribution of a refraction component formed by light refracted inside the biological sample and a phase distribution of a structure component formed by light diffracted in a structure inside the biological sample;
merging the phase distribution of the refraction component and the phase distribution of the structure component to calculate the phase distribution of the biological sample, and forming a phase distribution image from the calculated phase distribution of the biological sample; and
merging the phase distribution image of the biological sample with an image of the biological sample in which a biochemical phenomenon and/or a physical phenomenon in the biological sample are visualized and which is obtained using a method that is different from a method used for the phase distribution image.

2. The image forming method according to claim 1, wherein
the microscope is a differential interference contrast microscope that images a phase distribution of an observed object as an image intensity distribution;
and the image forming method further comprises:
switching a shear direction of the microscope; and
merging two phase distributions of the biological sample calculated in two shear directions before and after the switching.

3. The image forming method according to claim 1, further comprising:
applying a deconvolution process to the structure component using an optical response characteristic in a state of defocusing with respect to an observation plane to calculate a second phase distribution of the structure component;
comparing the second phase distribution of the structure component and the phase distribution of the structure component calculated using an optical response characteristic in a focused state with respect to the observation plane; and
removing a phase distribution in which the defocusing has caused a blur from the phase distribution of the structure component, according to a comparison result of the phase distributions;
wherein
the forming of the phase distribution image includes merging of a phase distribution in which the phase distribution in which the defocusing has caused a blur has been removed from the phase distribution of the structure component with the phase distribution of the refraction component.

4. The image forming method according to claim 1, further comprising:
changing a focal plane in an optical axis direction with respect to an observation plane;
comparing phase distributions of the structure component calculated for respective focal planes, to identify a phase distribution leaking from structures of the biological sample above and below the observation plane into the observation plane; and
removing the identified phase distribution from the phase distribution of the structure component.

5. The image forming method according to claim 1, wherein
the merging of the phase distribution image of the biological sample with the image obtained using a method that is different from a method used for the phase distribution image includes
performing position matching between the images according to coordinate information of the phase distribution image and coordinate information of the image obtained using a method that is different from a method used for the phase distribution image; and
merging the phase distribution image with the image obtained using a method that is different from a method used for the phase distribution image for which position matching has been performed.

6. The image forming method according to claim 1, wherein
the merging of the phase distribution image of the biological sample with the image obtained using a method that is different from a method used for the phase distribution image includes
performing position matching between the images according to coordinate information and angle information of the phase distribution image and coordinate information and angle information of the image obtained using a method that is different from a method used for the phase distribution image; and
merging the phase distribution image with the image obtained using a method that is different from a method used for the phase distribution image for which position matching has been performed.

7. The image forming method according to claim 5, wherein
the merging of the phase distribution image of the biological sample with the image obtained using a method that is different from a method used for the phase distribution image further includes performing matching of magnifications between the images according to magnification information of the phase distribution image and magnification information of the image obtained using a method that is different from a method used for the phase distribution image.

8. The image forming method according to claim 1, wherein
the image obtained using a method that is different from a method used for the phase distribution image is an image formed according to light emitted from the biological sample.

9. The image forming method according to claim 8, wherein
the image obtained using a method that is different from a method used for the phase distribution image is a fluorescence image of the biological sample.

10. An image forming apparatus comprising:
a microscope that converts a phase distribution of a biological sample into an image intensity distribution and that includes an image contrast changing unit which changes an image contrast of the image intensity distribution;
a control unit which controls the image contrast changing unit so as to obtain a plurality of pieces of images with different image contrasts;
an operating unit which calculates a component corresponding to the phase distribution of the biological sample and a component corresponding to a matter other than the phase distribution of the biological sample according to the plurality of pieces of images obtained with control by the control unit, and forms a normalized phase component image by dividing the component corresponding to the phase distribution by the component corresponding to the matter other than the phase distribution of the biological sample; separates the phase component image into a plurality of frequency components according to spatial frequencies of the image; applies a deconvolution process to each of the frequency components using an optical response characteristic corresponding to each, to calculate a phase distribution of a refraction component formed by light refracted inside the biological sample and a phase distribution of a structure component formed by light diffracted in a structure inside the biological sample; and merges the phase distribution of the refraction component and the phase distribution of the structure component to calculate the phase distribution of the biological sample, and forms a phase distribution image from the calculated phase distribution of the biological sample; and
a merging unit which merges an image of the biological sample in which a biochemical phenomenon and/or a physical phenomenon in the biological sample are visualized and which is obtained using a method that is different from a method used for the phase distribution image with the phase distribution image of the biological sample formed by the operating unit.

11. The image forming apparatus according to claim 10, wherein
the merging unit is configured
to perform position matching between the images according to coordinate information of the phase distribution image and coordinate information of the image obtained using a method that is different from a method used for the phase distribution image; and
to merge the phase distribution image with the image obtained using a method that is different from a method used for the phase distribution image for which position matching has been performed.

12. The image forming apparatus according to claim 10, wherein
the image obtained using a method that is different from a method used for the phase distribution image is a fluorescence image of the biological sample.

13. The image forming apparatus according to claim 10, wherein
the image obtained using a method that is different from a method used for the phase distribution image is obtained by the microscope.

14. The image forming apparatus according to claim 13, wherein
the image obtained using a method that is different from a method used for the phase distribution image is an image formed according to light emitted from the biological sample.

15. The image forming apparatus according to claim 14, wherein
the image obtained using a method that is different from a method used for the phase distribution image is a fluorescence image of the biological sample.
